(19) United States
(12) Patent Application Publication
(10) Pub. No.: US 2012/0004113 A1
(43) Pub. Date: Jan. 5, 2012

(54) DNA CHIP, KIT FOR DETECTING OR GENOTYPING BACTERIA CAUSING SEXUALLY TRANSMITTED DISEASES, GENOTYPING ANTIBACTERIAL DRUG RESISTANCE AND DETECTING OR GENOTYPING METHOD USING THE SAME

(75) Inventor: Woo Chul Moon, Gangnam-gu (KR)

(73) Assignee: GOODGENE INC., Seoul (KR)

(21) Appl. No.: 13/131,207

(22) PCT Filed: Dec. 17, 2008
(86) PCT No.: PCT/KR2008/007492

§ 371 Date: May 25, 2011

(30) Foreign Application Priority Data
Nov. 25, 2008 (KR) 10-2008-0117508

(51) Int. Cl. C40B 20/00; C40B 40/06

(52) U.S. Cl. 506/2; 506/16

(57) ABSTRACT

Disclosed are a DNA chip and a kit capable of quickly and accurately detecting or genotyping the highly prevalent and important eleven microbes causing sexually transmitted diseases (STD) Neisseria gonorrhoeae, Chlamydia trachomatis, Ureaplasma urealyticum, Mycoplasma genitalium, Mycoplasma hominis, syphilis-causing treponema, pallidum, chancroid-causing Haemophilus ducreyi, genital herpes-causing herpes simplex virus 1 and 2, human papillomavirus (HPV) and Trichomonas vaginalis and three related organisms Candida albicans, Gardnerella vaginalis and coliform bacteria and analyzing antibiotic resistance against tetracycline and lactam antibiotics, and a method for detecting or genotyping using the same. According to the present invention, the presence, genotype and antibiotic resistance of the fourteen organisms can be analyzed quickly and accurately from a DNA sample. With excellent sensitivity, specificity, reproducibility and accuracy of the 14 STD-causing and related microorganisms may be automatically identified quickly and accurately from multiple samples, and selection of antibiotics may be aided.

### TECHNICAL FIELD

The present invention relates to a DNA chip and a kit capable of quickly and accurately detecting or genotyping the highly prevalent and important eleven microbes causing sexually transmitted diseases (STD) Neisseria gonorrhoeae, Chlamydia trachomatis, Ureaplasma urealyticum, Mycoplasma genitalium, Mycoplasma hominis, syphilis-causing Treponema pallidum, chancroid-causing Haemophilus ducreyi, genital herpes-causing herpes simplex virus 1 and 2, human papillomavirus (HPV) and Trichomonas vaginalis and three related organisms Candida albicans, Gardnerella vaginalis and coliform bacteria and analyzing antibiotic resistance against tetracycline and β-lactam antibiotics, and a method for detecting or genotyping using the same. According to the present invention, the presence, genotype and antibiotic resistance of the fourteen organisms can be analyzed quickly and accurately from a DNA sample.

### BACKGROUND ART

Microbial infection is still one of the most important human diseases. In the diagnosis of microbial infection, it is important to quickly and accurately identify the causual microbes and to determine their sensitivity and resistance to antibiotics. When detecting the causual microbe, it is important to identify not just the genus and species but also its subtype or strain. Such detailed information is essential in the understanding of the source and cause of infection, identification of condition, prediction of progress and prognosis, selection of therapeutic agent and determination of therapy, and development and administration of vaccine.

Traditionally, a variety of techniques have been used for diagnosis infectious diseases, including microscopic examination aided by staining, cultivation, antibiotic sensitivity test, antigen-antibody assay, immunoassay, or the like. However, these traditional diagnosis techniques have many restrictions. The existing techniques are inapplicable for a large number of microbes, require a lot of time, cost and labor, are limited in the number of samples that can be treated at once, often allow only one assay at a time, and have many problems for clinical application because of unautomated interpretation. In addition, because the microbe has to survive until the assay, handling and transportation of the sample are difficult and expensive.

Recently, molecular genetic techniques have been introduced to diagnosis of infectious diseases, and they are replacing the traditional diagnosis techniques fast. Especially, DNA microarray or DNA chip enabling automated analysis of a plurality of samples is gaining spotlight. Infection diagnosis based on genetic analysis is increasing as supplementary or alternative diagnosis because it is advantageous over the existing methods in many aspects. Through DNA and RNA base sequencing, the genetic diagnosis allows identification of even subtype or strain, and handling and transportation of the sample are easy because dead microbes can be detected. Further, it provides high sensitivity because the representative genes may be amplified by polymerase chain reaction (PCR), and diagnosis is possible even with a trace amount of sample. In addition to sensitivity, it is superior in specificity and reproducibility. In most cases, the result can be attained quickly and accurately, within 24 hours, with less labor and cost. In addition, the use of a DNA chip enables quick examination of a large number of samples, which will be of great help for hospitals.

At present, PCR and real time PCR kits for detecting Chlamydia trachomatis, Neisseria gonorrhoeae, herpes simplex virus, human immunodeficiency virus (HIV), etc., which are approved by the Food and Drug Administration (FDA), are commercially available. However, there are not many commercialized DNA chips as yet. Moreover, the DNA chips that can quickly and accurately detect the causal microbes of infectious diseases and analyze antibiotic resistance to be of help to clinical diagnosis are rare. Especially, there is no commercially available sexually transmitted disease (STD) chip capable of detecting the main causal microbes of STD and related organisms and analyzing their antibiotic resistance as yet (Andrea Ferreria-Gonzalez, Angela M Calieno, Tiez, Textbook of Clinical Chemistry and Molecular Biology, 4th Edition, Elsevier Saunders, 2006. p. 1555-1588).

STD refers to the diseases that are propagated by means of human sexual behavior. STD is very important, in that 5 of the 10 major human infectious diseases are STDs and it is the most common and has the longest history among all human infectious diseases. In the United States, more than 1,500 people are newly infected with STDs every year and more than 65 million people are infected with viral STDs. Recently, especially infection by Chlamydia trachomatis, herpes simplex virus and human papillomavirus (HPV) are increasing. They are pointed out as the most frequent three STDs. In spite of the high prevalence of STD, many cases go unnoticed because of no symptom. Untreated STDs can lead to infertility or complications such as prostatitis, epididymitis, immunodeficiency, cancer, etc. In many cases, there is no effective treatment for STDs, particularly viral STDs. Because of this, accurate diagnosis and prevention of STD is very important. In addition, it is important to find patients with no symptom and treat them to prevent the spread of infection (Tara Frenkl, Jeanette Potts, Campbell-Walsh, Urology, 9th edition, Saunders, 2007, p. 371-385).

The representative causual microbes of STD include the bacteria Neisseria gonorrhoeae, Chlamydia trachomatis, Ureaplasma urealyticum, Mycoplasma genitalium, Mycoplasma hominis, Treponema pallidum and Haemophilus ducreyi, the viruses herpes simplex virus, HPV, HIV and hepatitis virus, the protozan Trichomonas vaginalis, or the like.

STDs can be largely classified into four types. The first type, which is caused by Neisseria gonorrhoeae, Chlamydia trachomatis, Ureaplasma urealyticum, Mycoplasma genitalium, Mycoplasma hominis, Trichomonas vaginalis and herpes simplex virus, develops as urethritis, prostatitis or epididymitis in men and as cervicitis, vaginitis or pelvic inflammatory disease in women. The second type, which develops as ulcer in the external genitalia, is caused by syphilis-causing Treponema pallidum, herpes simplex virus or Haemophilus ducreyi. The third type, which leads to genital warts or cancers in the cervix, anus, penis, etc. is caused by HPV. The fourth type, which leads to systemic infection, is caused by HIV or other viruses. Besides, although coliform bacteria and Gardnerella vaginalis and the fungus Candida albicans do not cause STDs in critical sense, they need to be detected because they develop conditions similar to STD, such as vaginitis. These microbes will have to be included in the diagnosis of STD.

The applicant of the present invention (Goodgene, Inc.) has detected STD-causing organisms in about 500,000 people for about 7 years by means of various genetic analyses. The detection result in 101,578 people for the past year is shown in Table 1.

TABLE 1
Genetic analysis result on STD in 101,578 people for the last year

| Microorganisms | Positive cases | % |
|---|---|---|
| Neisseria gonorrhoeae | 821 | 1.65 |
| Chlamydia trachomatis | 3,925 | 7.88 |
| Ureaplasma urealyticum | 4,943 | 9.93 |
| Mycoplasma genitalium | 2,053 | 4.12 |
| Mycoplasma hominis | 3,733 | 6.89 |
| Trichomonas vaginalis | 676 | 1.36 |
| Gardnerella vaginalis | 6,572 | 13.20 |
| Candida albicans | 422 | 0.85 |
| Treponema pallidum | 38 | 0.08 |
| HSV type I | 50 | 0.1 |
| HSV type II | 230 | 0.46 |
| HPV | 26,337 | 52.89 |
| Total | 49,800 | 100 |

Based on these experiences, the inventors of the present invention have found that there are many problems to be solved with regard to the diagnosis of STD.

First, unlike other diseases, many cases go unnoticed, because of no symptom, until the condition becomes severe. And, reinfection occurs frequently following treatment. Actually, in many cases, infection of non-gonococcal urethritis by Chlamydia trachomatis, Ureaplasma, Mycoplasma, etc. goes unnoticed because of no symptom. Accordingly, it is important to develop a method of detecting the STD-causing organisms early and effectively screening out those who carry the organisms even without a symptom.

Second, diagnosis is not practically easy. Most of STD-causing organisms are not cultivated well and are not detected immunologically. If the immunological detection is possible, too much time and cost are required. Thus, in many cases, doctors make diagnoses based on experiences and intuitions. Therefore, a new method for diagnosis of STD, which is accurate, fast and inexpensive, is desperately required.

Third, STD frequently occurs as complicated infection. For example, in case of gonococcal infection, complicated infection with Neisseria gonorrhoeae, Chlamydia trachomatis and herpes simplex virus is not uncommon, as shown in FIG. 1. Accordingly, a method enabling accurate diagnosis of such complicated infection is desperately required.

The fourth problem is antibiotic resistance. Especially, major STD bacteria including Neisseria gonorrhoeae and Chlamydia frequently show resistance to β-lactam and tetracycline antibiotics. This is a serious problem in clinical practice, which leads to treatment failure, complications, spread of infection and economic loss. Accordingly, it is important to quickly and accurately analyze the antibiotic resistance and to select an adequate antibiotic.

For these reasons, there are many difficulties in the diagnosis of STD. The present invention was made to solve these problems.

Clinically, the most common type of STD is inflammation of the urethra of both sexes and the cervix, vagina, oviduct, etc. of women. It may be classified into gonococcal and non-gonococcal inflammations. The latter is mainly caused by Chlamydia trachomatis, Ureaplasma urealyticum, Mycoplasma genitalium and Mycoplasma hominis. These bacteria are the main cause of urethritis in men. Also, they may cause complications such as epididymitis and prostatitis, and are the important cause of infertility. In women, they are the important cause of urethritis, vaginitis, cervicitis and pelvic inflammatory disease and may lead to infertility and complications such as ectopic pregnancy by obstructing the Fallopian tube. Chlamydia infection is the most common in Europe and America, and, also in Korea, Chlamydia infection and non-gonococcal urethritis are increasing whereas gonorrhea is decreasing. This coincides with our empirical data (see Table 1).

If urethritis is found in a patient, it should be determined whether it is gonococcal or non-gonococcal. It is because the therapy and development are different. However, because of increased mutation caused by misuse of antibiotics and complicated infection, there are many cases where the distinction is difficult. For accurate diagnosis, a molecular genetic method like the present invention is necessary.

Neisseria gonorrhoeae (N. gonorrhoeae) casusing gonococcal urethritis belongs to the genus Neisseria. Detection of Neisseria gonorrhoeae is primarily based on Gram staining. Identification of the presence of Gram-negative diplococcus bacterium in cells by Gram staining is widely applied because it is simple and relatively accurate. However, in case of gonococcal urethritis with no or slight symptoms, Gram staining may give indefinite or false negative result. Thus, there has been an attempt to cultivate Neisseria gonorrhoeae to complement the Gram staining. But, it requires a lot of time and cost.

In addition, enzyme immunoassay (EIA) and immunofluorescence techniques are utilized as a new tool for antigen identification in diagnosis of gonococcal infections. Although they produce results quicklier than cultivation tests and provide higher sensitivity and specificity, they are expensive.

Recently, non-gonococcal urethritis is increasing although gonococcal urethritis is decreasing. Non-gonococcal urethritis is not a single disease but a kind of syndrome that can be caused by various microbes. The most important of the non-gonococcal urethritis causing microbes is Chlamydia trachomatis. Chlamydia trachomatis is a bacterium having intracellular parasitism in its life cycle. Its genome has both DNAs and RNAs. Of the total 15 serotypes, it is the D-K serotype that causes non-gonococcal urethritis. The bacterium may cause trachoma, respiratory tract infection and STDs such as urethritis, cervicitis, epididymitis and pelvic inflammatory disease in humans. Recently, it was reported that Chlamydia may cause myocarditis.

For detection of Chlamydia trachomatis, (1) cultivation and isolation of sample taken from the infected site, (2) direct staining of epithelial cells at the infected site, and (3) fluorescent antibody technique of isolating antibody from the serum of the patient have been used. Recently, (4) molecular genetic techniques such as PCR and hybridization are preferred. The method (1) is inadequate for clinical diagnosis because the cultivation and isolation of sample requires a long time and the diagnosis sensitivity is low. Although the method (2) is simple since the bacterium is identified by directly staining the epithelial cells at the infected site, the diagnosis sensitivity is low. The method (3) is relatively sensitive because fluorescein isothiocyanate (FITC)-labeled monoclonal antibody is used. However, it is expensive and requires special equipments.

Ureaplasma urealyticum and Mycoplasma genitalium, which extensively exist in humans and various mammals and may cause genitourinary infections, are technically very difficult to cultivate and find by staining or immunological method. Thus, it is the recent trend to detect them by molecular genetic assays using PCR. Usually, the base sequence of the DNA genes characteristic of each bacterium is amplified by PCR and is identified by sequencing, hybridization, or the like. The 13 Mycoplasma species and 2 Ureaplasma species known thus far have identical base sequences at the 5′ flanking region of V3 and the 3′ flanking region of V6 of 16S ribosomal RNA (16S rRNA). About 250 bases of V4 and V5 and the region between the 16S and 23S rRNAs have different base sequences depending on species. Accordingly, detection can be made based thereon. Further, in case of Ureaplasma urealyticum, detection can be made by sequencing its specific urease subunit (Jensen J S et al., J. Clin. Microbiol. 2003; 41: 261-6; Yoshida T et al., J. Clin. Microbiol. 2002; 40: 105-110).

Another common type of STDs is those resulting in ulcers in the external genitalia. Representative examples are genital herpes, syphilis, chancroid, lymphogranuloma venereum (LGV). They are caused by herpes simplex virus 1 and 2 (HSV-1 and HSV-2), Treponema pallidum, Haemophilus ducreyi and Chlamydia trachomatis, respectively (Tara Frenkl, Jeanette Potts, Campbell-Walsh Urology, 9th edition, Saunders, 2007, p. 371-385). The inventors of the present invention have developed a new genetic diagnosis kit capable of amplifying the genital ulceration-causing bacteria at the same time by multiplex PCR and detecting them on a DNA chip by reverse hybridization.

Herpes simplex virus is the major cause of genital ulceration. There are two types of herpes simplex virus, HSV-1 and HSV-2. Especially, HSV-2 is more often associated with genital herpes. However, because of oral sex, genital herpes caused by HSV-1 is increasing recently. Our statistics also show that 60.9% of the patients who had genital ulceration were identified to have STDs and, among them, 79.9% was caused by HSV-2 and 17.4% was caused by HSV-1. Herpes simplex virus hides in the nervous system and causes blisters and ulcers at the genitals when the body's immune system becomes weaker. Therefore, many people do not know that they are infected. Actually, herpes simplex infection is the most prevalent as a single STD. In the US, it is estimated that about 45 million people are infected by herpes simplex virus and 1 million are newly infected every year (Centers for Disease Control and Prevention webpage. CDC Fact Sheet: Genital Herpes). Formerly, infection by herpes simplex virus was diagnosed by cultivation test. But, diagnosis has been made empirically, without test, because the method is insensitive and requires a lot of time and cost. However, for best treatment, an accurate diagnosis is essential and distinction has to be made between HSV-1 and HSV-2. In case of HSV-1 infection, the average recurrence is only once in the first year and the recurrence decreases thereafter. In contrast, HSV-2 is associated with frequent recurrence, as many as 4 times on average in the first year. Accordingly, in case of HSV-2 infection, a more aggressive treatment and a careful follow-up are essential (Tara Frenkl, Jeanette Potts, Campbell-Walsh Urology, 9th edition, Saunders, 2007, p. 371-385). Tests for herpes simplex virus infection approved by the FDA include the antibody tests Herpes-Select ELISA, Herpes-Select Immunoblot, Capita ELISA, or the like. Recently, simple genetic tests using PCR or Light Cycler Assay are used without approval from the FDA. However, there are few commercialized genetic analysis techniques capable of accurately detecting HSV-1 and HSV-2 (Andrea Ferreria-Gonzalez, Angela M Calieno; Tiez Textbook of Clinical Chemistry and Molecular Biology, 4th Edition, Elsevier Saunders, 2006. p. 1555-1588). Therefore, the inventors of the present invention have developed a new kit capable of detecting not only the infection by herpes simplex virus but also its subtypes, i.e. whether it is HSV-1 or HSV-2, which performs PCR and analyzes the product on a DNA chip by reverse hybridization. This method is more sensitive and specific than electrophoresis following PCR (Olive D M, Bean P. Journal of Clinical Microbiology. June 1999. p. 1661-1669.).

Syphilis is a STD with the longest history. Although the disease decreased remarkably with the advent of penicillin, its prevalence is reportedly increasing again in white men in the US and Europe (Centers for Disease Control and Prevention, CDC Fact Sheet, Syphilis, 2006; Tara Frenkl, Jeanette Potts, Campbell-Walsh Urology, 9th edition, Saunders, 2007, p. 371-385). There are many problems to be solved with respect to diagnosis of syphilis. Traditionally, syphilis has been diagnosed by serum examination followed by observation of the spirochetal bacterium Treponema pallidum under a dark field microscope. However, the dark field observation requires experiences and the diagnosis sensitivity is low at an early stage of the disease. The antibody test also cannot diagnose syphilis until 1-3 weeks after the formation of chancres. The so-called gold standard assay, rabbit infectivity assay, is accurate, but it requires animal test and needs a lot of time and cost. For these reasons, PCR and reverse transcription (RT) PCR are attempted recently to allow early diagnosis. For accuracy and discrimination with other spirochetal bacteria, 47 kDa gene, 16S rRNA, DNA polymerase I, rpf-1, rmp A, rmp B and BMP genes of Treponema pallidum are amplified during PCR. However, their respective significance is not still clearly elucidated and there is no commercialized genetic assay kit (Liu H, Rodes B, Chen C Y, Steiner B. Journal of Clinical Microbiology. May 2001. p. 1941-1946). Thus, in order to enable accurate diagnosis of syphilis more early, the inventors of the present invention have developed a method improved over PCR only in sensitivity and specificity, whereby the carboxypeptidase gene of Treponema pallidum is amplified by PCR and the product is reconfirmed on a DNA chip by reverse hybridization.

Chancroid is decreasing recently in the US and Europe. The STD is rare in Koreans living in Korea. The chancroid causing bacterium Haemophilus ducreyi is commonly detected by Gram staining of ulcer, but the accuracy is limited. The bacterium is also very difficult to culture. For these reasons, PCR is viewed as a new standard diagnosis method. However, there is no test method approved by the FDA as yet. Once chancroid is identified, it is recommended to examine syphilis and HIV infection (Centers for Disease Control and Prevention, CDC Fact Sheet, Chancroid, 2006; Tara Frenkl, Jeanette Potts, Campbell-Walsh Urology, 9th edition, Saunders, 2007, p. 371-385). The inventors of the present invention have developed a new method of amplifying the 16S rRNA gene of chancroid-causing Haemophilus ducreyi by PCR and reconfirming the product on a DNA chip by reverse hybridization, in order to improve diagnosis sensitivity and specificity.

At present, the most important and common two STDs invading human external genitalia are genital herpes and HPV infection. In the US, about 25 million people are infected by HPV and over 6 million are newly infected every year. It is estimated that about half of adult males and females are infected at least once during their lives (CDC Fact Sheet, USA, 2006). According to our experiences, the most frequently found STD was HPV infection (see Table 1). More than 100 HPV types have been identified. About 40 types are anogenital type or mucosal type that invade the mucous membranes of external genitalia or anus. HPV can be divided into two types depending on disease conditions. The so-called low-risk HPV types cause warts or condyloma accuminata. The other high-risk HPV types can lead to precancerous lesions or cancers of the cervix, penis, anus, or the like. Diagnosis of HPV infection involves three stages. The first is to identify HPV infection. For this purpose, PCR followed by identification with electrophoresis or hybridization is commonly employed. The second is to identify the risk of HPV to screen out cervical cancer. For this purpose, the hybrid-capture assay (Digene Corporation, USA) approved by the FDA is widely used. The third is to identify the accurate subtype or genotype of HPV (genotyping test). This may be applied not only to diagnose STD infection but also to screening of cervical cancer and determining applicability of HPV vaccines. The representative genotyping test involves PCR followed by base sequencing. However, because this procedure requires a lot of time and cost and is labor-intensive, only a small number of samples can be tested at once (Olive D M, Bean P. Journal of Clinical Microbiology. June 1999. p. 1661-1669.). For this reason, recently, genotyping is carried out by performing reverse hybridization on a DNA chip using multiple probes following PCR. The inventors of the present invention have developed and patented such an HPV genotyping DNA chip and are marketing the product with approval from the Korea Food & Drug Administration (KFDA) and the CE. The inventors of the present invention have modified it and developed a convenient DNA chip technique capable of amplifying the L1 gene of HPV by PCR and reconfirming the product on a DNA chip by reverse hybridization.

Trichomonas vaginalis is a protozoan parasitic only in humans. It is the typical STD which is transmitted sexually, invades the urethra of men and women and the vagina of women and causes inflammation (trichomoniasis). It is a common STD. It is estimated that 174 million cases of infection are acquired annually worldwide and 6 million new infections occur in the US each year (WHO, 1999; Tara Frenkl, Jeanette Potts, Campbell-Walsh Urology, 9th edition, Saunders, 2007, p. 371-385). Infections in men are usually asymptomatic and, thus, go unnoticed in most cases. About half of infections in women are also asymptomatic. Customarily, when a patient with symptom visits the hospital, diagnosis is made based on physical examination or microscopic observation (wet smear). It is important to develop a method capable of finding an asymptomatic carrier. In this regard, the inventors of the present invention have developed a DNA chip kit capable of quickly and accurately detecting Trichomonas from urine, vaginal smear or urethral smear.

Although not causing STD in the strict sense, Candida albicans, Gardnerella vaginalis and coliform bacteria need to be detected because they cause vaginitis and lower urinary tract infection similarly to STD and, thus, require differential diagnosis.

Candida albicans is the most common causative agent of vulvovaginitis. It may normally be present on the vaginal and penile skin, and may be propagated through sexual intercourse. Diagnosis is made by wet smear test (Gram staining) of vaginal discharge. It is characterized by normal vaginal pH and frequent recurrence. A genetic diagnosis kit for the organism is not commercially available yet. The inventors of the present invention have included a DNA chip kit for detecting the fungus for differential diagnosis from STD.

Gardnerella vaginalis is a bacterium replacing parasitic bacteria in normal vagina of women and causing bacterial vaginosis. Diagnosis is made by mixing vaginal discharge with potassium hydroxide and performing staining test (Whiff test). It is characterized by increased vaginal pH. A commercialized DNA probe kit has been provided recently, but there is no DNA chip as yet. The inventors of the present invention have included a DNA chip kit for detecting the bacteria for differential diagnosis from STD.

Coliform bacteria are the main cause of cystitis in women and prostatitis in men. It is important to diagnose it differentially from other STDs including vaginitis and pelvic inflammatory disease in women and urethritis in men. Coliform bacteria are customarily identified through cultivation test urine, but it takes a long time of 48-72 hours. There is no commercially available DNA chip for detecting coliform bacteria as yet. The inventors of the present invention have included a DNA chip kit for detecting the bacteria for fast differential diagnosis from STD.

Another serious problem associated with STD is antibiotic resistance. For treatment of the representative STD bacterium Neisseria gonorrhoeae, β-lactam antibiotics such as penicillin, ampicillin and cephalosporin, tetracycline antibiotics such as oxytetracycline, and quinolone antibiotics are used. Recently, Neisseria gonorrhoeae resistant to these antibiotics are increasing rapidly. Likewise, tetracycline antibiotics or quinolone antibiotics are used to treat chlamydial infection, but Chlamydia bacteria resistant to these antibiotics are increasing rapidly. Accordingly, a genetic test, particularly a DNA chip, capable of accurately and simultaneously analyzing the antibiotic resistance is necessary, but it is rare.

For the genetic diagnosis to be clinically of help, it needs to satisfy a number of requirements. First, sensitivity, specificity and reproducibility of diagnosis should be close to 100%. In addition, the test procedure should be convenient, easy to interpret and simple. The result should be attained quickly and the test should be possible without special expensive equipments. The test should be automated for testing of a lot of specimen quickly and at low cost. For this purpose, multiplex PCR capable of amplifying and identifying multiple microorganisms in a tube at once is adequate. Further, target genes and sequencing sites should be adequately selected for accurate identification of up to the subtype level and optimized PCR condition should be established. However, there is no DNA chip or multiplex PCR capable of identifying the fourteen STD-causing and related microorganisms as yet, not to mention a commercialized PCR kit.

PCR is merely a means of amplifying nucleic acids and cannot ensure detection of microorganisms. Following PCR, a procedure of accurately determining to which microorganism the amplified DNA belongs is necessary. Besides, it is important to accurately genotype the microorganisms for accurate prediction of antibiotic resistance, biological invasion, prognosis, etc., if possible. For this purpose, development of a DNA chip capable of accurately and quickly identifying various STD-causing microorganisms at once, differentiating from other diseases and giving information on antibiotic resistance, is imminent.

Thus, the inventors of the present invention have developed a DNA chip and a kit capable of accurately detecting or genotyping the 14 STD-causing microorganisms and analyzing antibiotic resistance against tetracycline and β-lactam antibiotics, and a method for detecting or genotyping using the same, for application to actual diagnosis.

The inventors of the present invention have already developed, patented (Korean Patent No. 619189) and commercialized a multiplex PCR and oligonucleotide microarray capable of detecting the presence of Neisseria gonorrhoeae, Chlamydia trachomatis, Ureaplasma urealyticum and Mycoplasma genitalium at once and analyzing the bacteria's resistance to tetracycline antibiotics.

Further on, they have developed a DNA chip and a multiplex PCR kit capable of quickly and accurately further detecting and genotyping Mycoplasma genitalium, Mycoplasma hominis, syphilis-causing Treponema pallidum, chancroid-causing Haemophilus ducreyi, genital herpes-causing HSV-1 and HSV-2, HPV and Trichomonas vaginalis, which are causative of STD, and Candida albicans, Gardnerella vaginalis and coliform bacteria, which need to be differentiated from STD, and analyzing resistance to tetracycline and β-lactam antibiotics.

### DISCLOSURE

### Technical Problem

An object of the present invention is to provide a DNA chip and a kit capable of quickly and accurately detecting or genotyping the important microbes causing sexually transmitted diseases (STD) and related organisms Neisseria gonorrhoeae, Chlamydia trachomatis, Ureaplasma urealyticum, Mycoplasma genitalium, Mycoplasma hominis, syphilis-causing Treponema pallidum, chancroid-causing Haemophilus ducreyi, herpes simplex virus 1 and 2 (HSV-1 and HSV-2), human papillomavirus (HPV) and Trichomonas vaginalis, Candida albicans, Gardnerella vaginalis and coliform bacteria, and analyzing antibiotic resistance against tetracycline and β-lactam antibiotics, and a method for detecting or genotyping using the same, for application to clinical diagnosis. According to the present invention, the representative STD-causing and related microorganisms may be automatically identified quickly and accurately, and selection of antibiotics may be aided.

The detailed objects and purposes of the present invention are as follows.

Firstly, the present invention is directed to providing a multiplex PCR method capable of amplifying and genotyping the genomic or cryptic plasmid genes of important STD-causing and related microorganisms Neisseria gonorrhoeae, Chlamydia trachomatis, Ureaplasma urealyticum, Mycoplasma genitalium, Mycoplasma hominis, Treponema pallidum, Haemophilus ducreyi, HSV-1 and HSV-2, HPV, Trichomonas vaginalis, Candida albicans, Gardnerella vaginalis and coliform bacteria and the genes involved in their resistance to tetracycline and β-lactam antibiotics through a small number of PCR reactions.

Secondly, the present invention is directed to providing primers effective for amplifying the genes of the above 14 microorganisms, the genes involved in their resistance to tetracycline and β-lactam antibiotics and human beta-globin genes by multiplex PCR.

Thirdly, the present invention is directed to providing an oligonucleotide probe capable of more accurately detecting the genes characteristic of the 14 microorganisms, the antibiotic resistance gene and the control genes.

Fourthly, the present invention is directed to providing a DNA chip with the probe capable of detecting and genotyping the genes of the 14 microorganisms and their antibiotic resistance genes.

Fifthly, the present invention is directed to providing a kit equipped with the probe for detecting and genotyping the genes of the 14 microorganisms and their antibiotic resistance genes.

Sixthly, the present invention is directed to providing a method for detecting and genotyping the 14 microorganisms and their antibiotic resistance genes using the probe.

### Technical Solution

Preferably, a DNA chip for detecting and genotyping sexually transmitted disease (STD)-causing microorganisms and for analyzing their antibiotic resistance of the present invention includes an oligonucleotide probe having a base sequence selected from SEQ ID Nos. 37 to 66. An oligonucleotide probe having a base sequence of SEQ ID No. 66 binds complementarily to a human beta-globin gene.

In the DNA chip of the present invention, the oligonucleotide probe having a base sequence of SEQ ID No. 66 binds complementarily to an oligonucleotide having a base sequence of SEQ ID No. 67 with the 5′ end labeled with Cy5.

Preferably, the DNA chip of the present invention, the area on which the probe is spotted is partitioned into 8 wells.

Preferably, a kit for detecting and genotyping STD-causing microorganisms and analyzing antibiotic resistance of the present invention includes the DNA chip, a primer set for amplifying DNAs of STD-causing microorganisms, and a labeling means for detecting the amplified DNAs binding complementarily to the DNA chip.

Preferably, the kit of the present invention includes a primer set for amplifying nucleic acids of Gardnerella vaginalis having base sequences of SEQ ID No. 1 and SEQ ID No. 2, a primer set for amplifying nucleic acids of Ureaplasma urealyticum having base sequences of SEQ ID No. 3 and SEQ ID No. 4, a primer set for amplifying nucleic acids of Mycoplasma hominis having base sequences of SEQ ID No. 5 and SEQ ID No. 6, a primer set for amplifying nucleic acids of Chlamydia trachomatis having base sequences of SEQ ID No. 7 and SEQ ID No. 8, a primer set for amplifying nucleic acids of Neisseria gonorrhoeae having base sequences of SEQ ID No. 9 and SEQ ID No. 10, a primer set for amplifying nucleic acids of Trichomonas vaginalis having base sequences of SEQ ID No. 11 and SEQ ID No. 12, a primer set for amplifying nucleic acids of Mycoplasma genitalium having base sequences of SEQ ID No. 13 and SEQ ID No. 14, a primer set for amplifying nucleic acids of Candida albicans having base sequences of SEQ ID No. 15 and SEQ ID No. 16, a primer set for amplifying nucleic acids of coliform bacteria having base sequences of SEQ ID No. 17 and SEQ ID No. 18, a primer set for amplifying nucleic acids of Haemophilus ducreyi having base sequences of SEQ ID No. 19 and SEQ ID No. 20, a primer set for amplifying nucleic acids of herpes simplex virus (HSV) having base sequences of SEQ ID No. 21 and SEQ ID No. 22, a primer set for amplifying nucleic acids of Treponema pallidum having base sequences of SEQ ID No. 23 and SEQ ID No. 24, a primer set for amplifying nucleic acids of human papillomavirus (HPV) having base sequences of SEQ ID No. 25 and SEQ ID No. 26, a primer set for amplifying SHV gene (beta-lactamase SHV-12 gene) having base sequences of SEQ ID No. 27 and SEQ ID No. 28, a primer set for amplifying TEM gene (CMT-type beta lactamase gene) having base sequences of SEQ ID No. 29 and SEQ ID No. 30, a primer set for amplifying TetM gene (tetracycline resistant gene M) having base sequences of SEQ ID No. 31 and SEQ ID No. 32, a primer set for amplifying AmpC gene (cephalosporinase gene) having base sequences of SEQ ID No. 33 and SEQ ID No. 34, or a primer set for amplifying TetC gene (tetracycline resistant gene C) having base sequences of SEQ ID No. 35 and SEQ ID No. 36.

Preferably, in the kit of the present invention, the labeling means is one or more selected from a group consisting of Cy5, Cy3, biotinylated material, EDANS (5-(2′-aminoethyl)amino-1-naphthalenesulfonic acid), tetramethylrhodamine (TMR), tetramethylrhodamine isothiocyanate (TMRITC), x-rhodamine and Texas Red.

Preferably, in the kit of the present invention, the labeling means is Cy5 and labeled dCTP and unlabeled dCTP are reacted at a molar ratio of 1:12.5.

Preferably, a method for detecting and genotyping STD-causing microorganisms and analyzing antibiotic resistance according to the present invention includes: (a) amplifying DNAs of STD-causing microorganisms by single or multiplex PCR using a primer for amplifying nucleic acids of the STD-causing microorganisms; (b) hybridizing the amplified DNAs on the DNA chip according to any one of claims 1 to 4; and (c) detecting the hybridized product.

Preferably, in the method for detecting and genotyping STD-causing microorganisms and analyzing antibiotic resistance according to the present invention, the amplification by single or multiplex PCR is carried out using one or more primer set(s) selected from a group consisting of a primer set for amplifying nucleic acids of Gardnerella vaginalis having base sequences of SEQ ID No. 1 and SEQ ID No. 2, a primer set for amplifying nucleic acids of Ureaplasma urealyticum having base sequences of SEQ ID No. 3 and SEQ ID No. 4, a primer set for amplifying nucleic acids of Mycoplasma hominis having base sequences of SEQ ID No. 5 and SEQ ID No. 6, a primer set for amplifying nucleic acids of Chlamydia trachomatis having base sequences of SEQ ID No. 7 and SEQ ID No. 8, a primer set for amplifying nucleic acids of Neisseria gonorrhoeae having base sequences of SEQ ID No. 9 and SEQ ID No. 10, a primer set for amplifying nucleic acids of Trichomonas vaginalis having base sequences of SEQ ID No. 11 and SEQ ID No. 12, a primer set for amplifying nucleic acids of Mycoplasma genitalium having base sequences of SEQ ID No. 13 and SEQ ID No. 14, a primer set for amplifying nucleic acids of Candida albicans having base sequences of SEQ ID No. 15 and SEQ ID No. 16, a primer set for amplifying nucleic acids of coliform bacteria having base sequences of SEQ ID No. 17 and SEQ ID No. 18, a primer set for amplifying nucleic acids of Haemophilus ducreyi having base sequences of SEQ ID No. 19 and SEQ ID No. 20, a primer set for amplifying nucleic acids of herpes simplex virus (HSV) having base sequences of SEQ ID No. 21 and SEQ ID No. 22, a primer set for amplifying nucleic acids of Treponema pallidum having base sequences of SEQ ID No. 23 and SEQ ID No. 24, a primer set for amplifying nucleic acids of human papillomavirus (HPV) having base sequences of SEQ ID No. 25 and SEQ ID No. 26, a primer set for amplifying SHV gene (beta-lactamase SHV-12 gene) having base sequences of SEQ ID No. 27 and SEQ ID No. 28, a primer set for amplifying TEM gene (CMT-type beta lactamase gene) having base sequences of SEQ ID No. 29 and SEQ ID No. 30, a primer set for amplifying TetM gene (tetracycline resistant gene M) having base sequences of SEQ ID No. 31 and SEQ ID No. 32, a primer set for amplifying AmpC gene (cephalosporinase gene) having base sequences of SEQ ID No. 33 and SEQ ID No. 34, and a primer set for amplifying TetC gene (tetracycline resistant gene C) having base sequences of SEQ ID No. 35 and SEQ ID No. 36.

Preferably, in the method for detecting and genotyping STD-causing microorganisms and analyzing antibiotic resistance according to the present invention, the amplification by single or multiplex PCR includes: (a) mixing the primer set with template DNA, Taq DNA polymerase, dNTP, distilled water and PCR buffer; (b) predenaturing the resulting mixture at 95° C. for 10 minutes; (c) subjecting the resulting product to 40 cycles of denaturation at 94° C. for 30 seconds, primer annealing at 58° C. for 30 seconds and extension at 72° C. for 30 seconds; and (d) subjecting the resulting product to final extension at 72° C. for 5 minutes.

Preferably, in the method for detecting and genotyping STD-causing microorganisms and analyzing antibiotic resistance according to the present invention, the amplification by multiplex PCR is carried out using a primer set having base sequences of SEQ ID No. 1 and SEQ ID No. 2, a primer set having base sequences of SEQ ID No. 3 and SEQ ID No. 4, a primer set having base sequences of SEQ ID No. 5 and SEQ ID No. 6, a primer set having base sequences of SEQ ID No. 7 and SEQ ID No. 8, a primer set having base sequences of SEQ ID No. 9 and SEQ ID No. 10, a primer set having base sequences of SEQ ID No. 11 and SEQ ID No. 12, a primer set having base sequences of SEQ ID No. 13 and SEQ ID No. 14 and a primer set having base sequences of SEQ ID No. 15 and SEQ ID No. 16 at a molar ratio of 1:1:1:1:1:1:1:1.

Preferably, in the method for detecting and genotyping STD-causing microorganisms and analyzing antibiotic resistance according to the present invention, the amplification by multiplex PCR is carried out using a primer set having base sequences of SEQ ID No. 17 and SEQ ID No. 18, a primer set having base sequences of SEQ ID No. 19 and SEQ ID No. 20, a primer set having base sequences of SEQ ID No. 21 and SEQ ID No. 22, a primer set having base sequences of SEQ ID No. 23 and SEQ ID No. 24 and a primer set having base sequences of SEQ ID No. 25 and SEQ ID No. 26 at a molar ratio of 1:1:1:1:1.

Preferably, in the method for detecting and genotyping STD-causing microorganisms and analyzing antibiotic resistance according to the present invention, the amplification by multiplex PCR is carried out using a primer set having base sequences of SEQ ID No. 27 and SEQ ID No. 28, a primer set having base sequences of SEQ ID No. 29 and SEQ ID No. 30, a primer set having base sequences of SEQ ID No. 31 and SEQ ID No. 32, a primer set having base sequences of SEQ ID No. 33 and SEQ ID No. 34 and a primer set having base sequences of SEQ ID No. 35 and SEQ ID No. 36 at a molar ratio of 1:1:1:1:1.

Preferably, in the method for detecting and genotyping STD-causing microorganisms and analyzing antibiotic resistance according to the present invention, a PCR product by the primer set having base sequences of SEQ ID No. 1 and SEQ ID No. 2 has a size of 419 bp, a PCR product by the primer set having base sequences of SEQ ID No. 3 and SEQ ID No. 4 has a size of 373 bp, a PCR product by the primer set having base sequences of SEQ ID No. 5 and SEQ ID No. 6 has a size of 333 bp, a PCR product by the primer set having base sequences of SEQ ID No. 7 and SEQ ID No. 8 has a size of 321 bp, a PCR product by the primer set having base sequences of SEQ ID No. 9 and SEQ ID No. 10 has a size of 284 bp, a PCR product by the primer set having base sequences of SEQ ID No. 11 and SEQ ID No. 12 has a size of 262 bp, a PCR product by the primer set having base sequences of SEQ ID No. 13 and SEQ ID No. 14 has a size of 207 bp, and a PCR product by the primer set having base sequences of SEQ ID No. 15 and SEQ ID No. 16 has a size of 148 bp.

Preferably, in the method for detecting and genotyping STD-causing microorganisms and analyzing antibiotic resistance according to the present invention, a PCR product by the primer set having base sequences of SEQ ID No. 17 and SEQ ID No. 18 has a size of 467 bp, a PCR product by the primer set having base sequences of SEQ ID No. 19 and SEQ ID No. 20 has a size of 439 bp, a PCR product by the primer set having base sequences of SEQ ID No. 21 and SEQ ID No. 22 has a size of 350 bp, a PCR product by the primer set having base sequences of SEQ ID No. 23 and SEQ ID No. 24 has a size of 260 bp, and a PCR product by the primer set having base sequences of SEQ ID No. 25 and SEQ ID No. 26 has a size of 191 bp.

Preferably, in the method for detecting and genotyping STD-causing microorganisms and analyzing antibiotic resistance according to the present invention, a PCR product by the primer set having base sequences of SEQ ID No. 27 and SEQ ID No. 28 has a size of 679 bp, a PCR product by the primer set having base sequences of SEQ ID No. 29 and SEQ ID No. 30 has a size of 412 bp, a PCR product by the primer set having base sequences of SEQ ID No. 31 and SEQ ID No. 32 has a size of 291 bp, a PCR product by the primer set having base sequences of SEQ ID No. 33 and SEQ ID No. 34 has a size of 208 bp, and a PCR product by the primer set having base sequences of SEQ ID No. 35 and SEQ ID No. 36 has a size of 152 bp.

The inventors of the present invention have determined the test sites for the genes of the 14 microorganisms, 5 antibiotic resistance-related genes and human beta-globin gene and devised PCR primers for amplifying them (Example 1), prepared DNA clones for the representative genes of control microorganisms and each microorganism (Example 2), established methods for acquiring and storing clinical samples (Example 3), established methods for isolating DNA from the sample (Example 4), established single PCR conditions for the representative genes of the microorganisms (Example 5), performed single PCR and sequencing for the clinical sample and integrated the result into a database (Examples 6 and 7), established multiplex PCR conditions for the genes of the 14 microorganisms, 5 antibiotic resistance-related genes and human beta-globin gene (Example 8), performed multiplex multiplex PCR for human clinical samples to determine the applicability of the method (Example 9), designed probes for analyzing hybridization of the genes of the 14 microorganisms, 5 antibiotic resistance-related genes and human beta-globin gene and manufactured a DNA chip using them (Examples 10 and 11), established analysis conditions by performing analysis of Standard material using the DNA chip (Example 12), and confirmed that detection of infection by the 14 microorganisms as well as genotyping and analysis of antibiotic resistance is possible for clinical samples using the DNA chip.

In the DNA chip of the present invention, 5 to 7 probes may be used for the representative genes of the microorganisms. As a result, false negative and false positive errors that may occur when one probe is used for each gene may be avoided, and diagnosis sensitivity and specificity may be maximized.

In the DNA chip of the present invention, human beta-globin, actin or glyceraldehydes-3-phosphate dehydrogenase gene may be further included as a reference marker. In case the reference marker is beta-globin, it preferably has a base sequence of SEQ ID No. 66. By using the reference marker, hybridization on the DNA chip and the previous procedures of DNA isolation and PCR amplification can be verified and false negative error can be detected.

With the DNA chip of the present invention, the genes related to resistance against β-lactam and tetracycline antibiotics can be accurately detected to aid in the determination of therapeutic strategy. Preferably, the probes for the genes related to resistance against β-lactam and tetracycline antibiotics have base sequences of SEQ ID Nos. 56 to 65.

A method for manufacturing the DNA chip of the present invention comprises: preparing a DNA probe capable of complementarily binding to the nucleic acids of the STD-causing microorganisms, with the 5′ end of the base sequence bound to amine; binding the DNA probe on an aldehyde-bound solid surface; and reducing the aldehyde remaining without being bound to the DNA probe. The binding between the probe DNA and the aldehyde on the solid surface may be accomplished by Schiff base reaction of the amine and the aldehyde. The solid may be selected from glass, silicon dioxide, plastic or ceramic.

A kit comprising the DNA chip of the present invention may comprise a primer for amplifying nucleic acids of the STD-causing microorganisms, selected from the base sequences of SEQ ID Nos. 1 to 36, and a labeling means, and may further comprise a human beta-globin primer.

The labeling means may employ various known labels. For example, Cy5, Cy3, biotinylated material, EDANS, TMR, TMRITC, x-rhodamine or Texas Red may be used. If Cy5 is used, the labeled product may be directly detected via fluorescence signals using an analyzer such as a confocal laser scanner, without additional reactions. Therefore, it may be effective and sensitive

### Advantageous Effects

Using the DNA chip and the kit according to the present invention, it is possible to quickly and accurately detect infection by the most important eleven microbes causing sexually transmitted diseases (STD) Neisseria gonorrhoeae, Chlamydia trachomatis, Ureaplasma urealyticum, Mycoplasma genitalium, Mycoplasma hominis, syphilis-causing Treponema pallidum, chancroid-causing Haemophilus ducreyi, genital herpes-causing herpes simplex virus 1 and 2, human papillomavirus (HPV) and Trichomonas vaginalis and three related organisms Candida albicans, Gardnerella vaginalis and coliform bacteria and to analyze antibiotic resistance against tetracycline and β-lactam antibiotics. According to the present invention, sensitivity, specificity and reproducibility of STD diagnosis can be achieved nearly 100%, and complicated infection can also be detected accurately. In addition, the test procedure is convenient and easy to interpret. Also, it is economical because a number of samples can be accurately and automatically analyzed in short time. Accordingly, the present invention may be useful in primary screening or diagnosis of STDs, selection of antibiotics, determination of therapeutic strategies, post-treatment follow-up, or the like, and may replace existing commercialized DNA chips and kits based on cultivation, staining, immunological test, PCR, hybrid capture assay, and so on.

### DESCRIPTION OF DRAWINGS

The above and other aspects, features and advantages of the disclosed exemplary embodiments will be more apparent from the following detailed description taken in conjunction with the accompanying drawings.

FIG. 1 A shows a photograph of the DNA chip of the present invention. DNA probes are spotted on a slide at 8 different wells, so that different samples can be detected at the same time. FIG. 1 B schematically shows the order and location of the DNA probes for genotyping the genomic genes or plasmid genes of the 14 STD-causing microorganisms and for genotyping the genes related with antibiotic resistance. FIG. 1 C shows a fluorescence scanner image of a sample coinfected by Neisseria gonorrhoeae, Chlamydia trachomatis and herpes simplex virus 1 (HSV-1) and including genes resistant to penicillin- and tetracycline-based antibiotics, obtained with the DNA chip of the present invention.

FIG. 2 shows a fluorescence scanner image of a PCR product amplified using a primer set specifically binding to cryptic plasmid pJD1 of Neisseria gonorrhoeae, obtained with the DNA chip of the present invention.

FIG. 3 shows a fluorescence scanner image of a PCR product amplified using a primer set specifically binding to cryptic plasmid pUCH1 of Chlamydia trachomatis, obtained with the DNA chip of the present invention.

FIG. 4 shows a fluorescence scanner image of a PCR product amplified using a primer set specifically binding to 16S ribosomal RNA (rRNA) of Mycoplasma hominis, obtained with the DNA chip of the present invention.

FIG. 5 shows a fluorescence scanner image of a PCR product amplified using a primer set specifically binding to 16S rRNA of Mycoplasma genitalium, obtained with the DNA chip of the present invention.

FIG. 6 shows a fluorescence scanner image of a PCR product amplified using a primer set specifically binding to 18S rRNA of Candida albicans, obtained with the DNA chip of the present invention.

FIG. 7 shows a fluorescence scanner image of a PCR product amplified using a primer set specifically binding to UreB gene of Ureaplasma urealyticum, obtained with the DNA chip of the present invention.

FIG. 8 shows a fluorescence scanner image of a PCR product amplified using a primer set specifically binding to repeated DNA target gene of Trichomonas vaginalis, obtained with the DNA chip of the present invention.

FIG. 9 shows a fluorescence scanner image of a PCR product amplified using a primer set specifically binding to 16S-23S rRNA gene of Gardnerella vaginalis, obtained with the DNA chip of the present invention.

FIGS. 10 and 11 respectively show a fluorescence scanner image of a PCR product amplified using a primer set specifically binding to glycoprotein G-2 (US4) gene of HSV-1 and herpes simplex virus 2 (HSV-2), obtained with the DNA chip of the present invention.

FIG. 12 shows a fluorescence scanner image of a PCR product amplified using a primer set specifically binding to 16S rRNA of Haemophilus ducreyi, obtained with the DNA chip of the present invention.

FIG. 13 shows a fluorescence scanner image of a PCR product amplified using a primer set specifically binding to 47 kDa antigen gene of Treponema pallidum, obtained with the DNA chip of the present invention.

FIG. 14 shows a fluorescence scanner image of a PCR product amplified using a primer set specifically binding to L1 gene of human papillomavirus (HPV), obtained with the DNA chip of the present invention.

FIG. 15 shows a fluorescence scanner image of a PCR product amplified using a primer set specifically binding to 16S rRNA of coliform bacteria, obtained with the DNA chip of the present invention.

FIG. 16 shows a fluorescence scanner image of a PCR product amplified using a primer set specifically binding to SHV gene resistant to β-lactam (penicillin) antibiotics, obtained with the DNA chip of the present invention.

FIG. 17 shows a fluorescence scanner image of a PCR product amplified using a primer set specifically binding to TEM gene resistant to β-lactam (penicillin) antibiotics, obtained with the DNA chip of the present invention.

FIG. 18 shows a fluorescence scanner image of a PCR product amplified using a primer set specifically binding to TetM gene resistant to tetracycline antibiotics, obtained with the DNA chip of the present invention.

FIG. 19 shows a fluorescence scanner image of a PCR product amplified using a primer set specifically binding to AmpC gene resistant to β-lactam (penicillin) antibiotics, obtained with the DNA chip of the present invention.

FIG. 20 shows a fluorescence scanner image of a PCR product amplified using a primer set specifically binding to TetC gene resistant to tetracycline antibiotics, obtained with the DNA chip of the present invention.

FIG. 21 shows an electrophoresis result of single or multiplex PCR products for 8 STD-causing microorganisms. Lanes 1 to 9 are, respectively, for 100 by size marker and single PCR products of Gardnerella Ureaplasma urealyticum, Mycoplasma hominis, Chlamydia trachomatis, Neisseria gonorrhoeae, Trichomonas vaginalis, Mycoplasma genitalium and Candida albicans genes. Lane 10 is for multiplex PCR products of the genes of the 8 STD-causing microorganisms.

FIG. 22 shows an electrophoresis result of single or multiplex PCR products for 6 STD-causing microorganisms. Lanes 1 to 7 are, respectively, for 100 by size marker and single PCR products of coliform bacteria, HSV-1, HSV-2, Haemophilus ducreyi, Treponema pallidum and HPV genes. Lane 8 is for multiplex PCR products of the genes of the 6 STD-causing microorganisms.

FIG. 23 shows an electrophoresis result of single or multiplex PCR products for 5 antibiotic resistance genes. Lanes 1 to 6 are, respectively, for 100 by size marker and single PCR products of SHV gene, TEM gene, TetM gene, AmpC gene and TetC gene. Lane 7 is for multiplex PCR products of the 5 antibiotic resistance genes.

FIG. 24 shows an electropherogram of a PCR product amplified using a primer set specifically binding to plasmid pJD1 gene of Neisseria gonorrhoeae, analyzed using an automated sequencer.

FIG. 25 shows an electropherogram of a PCR product amplified using a primer set specifically binding to cryptic plasmid DNA of Chlamydia trachomatis, analyzed using an automated sequencer.

FIG. 26 shows an electropherogram of a PCR product amplified using a primer set specifically binding to 16S rRNA gene of Mycoplasma hominis, analyzed using an automated sequencer.

FIG. 27 shows an electropherogram of a PCR product amplified using a primer set specifically binding to 16S rRNA gene of Mycoplasma genitalium, analyzed using an automated sequencer.

FIG. 28 shows an electropherogram of a PCR product amplified using a primer set specifically binding to 18S rRNA gene of Candida albicans, analyzed using an automated sequencer.

FIG. 29 shows an electropherogram of a PCR product amplified using a primer set specifically binding to UreB gene of Ureaplasma urealyticum, analyzed using an automated sequencer.

FIG. 30 shows an electropherogram of a PCR product amplified using a primer set specifically binding to repeated DNA target gene of Trichomonas vaginalis, analyzed using an automated sequencer.

FIG. 31 shows an electropherogram of a PCR product amplified using a primer set specifically binding to 16S-23S rRNA gene of Gardnerella vaginalis, analyzed using an automated sequencer.

FIG. 32 shows an electropherogram of a PCR product amplified using a primer set specifically binding to glycoprotein G-2 (US4) gene of HSV-1, analyzed using an automated sequencer.

FIG. 33 shows an electropherogram of a PCR product amplified using a primer set specifically binding to glycoprotein G-2 (US4) gene of HSV-2, analyzed using an automated sequencer.

FIG. 34 shows an electropherogram of a PCR product amplified using a primer set specifically binding to 16S rRNA gene of Haemophilus ducreyi, analyzed using an automated sequencer.

FIG. 35 shows an electropherogram of a PCR product amplified using a primer set specifically binding to 47 kDa antigen gene of Treponema pallidum, analyzed using an automated sequencer.

FIG. 36 shows an electropherogram of a PCR product amplified using a primer set specifically binding to L1 gene of HPV, analyzed using an automated sequencer.

FIG. 37 shows an electropherogram of a PCR product amplified using a primer set specifically binding to SHV gene of microorganisms resistant to β-lactam antibiotics, analyzed using an automated sequencer.

FIG. 38 shows an electropherogram of a PCR product amplified using a primer set specifically binding to TEM gene of microorganisms resistant to β-lactam antibiotics, analyzed using an automated sequencer.

FIG. 39 shows an electropherogram of a PCR product amplified using a primer set specifically binding to TetM gene of microorganisms resistant to tetracycline antibiotics, analyzed using an automated sequencer.

FIG. 40 shows an electropherogram of a PCR product amplified using a primer set specifically binding to AmpC gene of microorganisms resistant to β-lactam antibiotics, analyzed using an automated sequencer.

FIG. 41 shows an electropherogram of a PCR product amplified using a primer set specifically binding to TetC gene of microorganisms resistant to tetracycline antibiotics, analyzed using an automated sequencer.

FIG. 42 shows a fluorescence scanner image of a multiplex PCR product of a sample coinfected by Neisseria gonorrhoeae, Chlamydia trachomatis, Mycoplasma genitalium and Gardnerella vaginalis, obtained with the DNA chip of the present invention.

FIG. 43 shows a fluorescence scanner image of a multiplex PCR product of a sample coinfected by HSV-2 and Treponema pallidum, obtained with the DNA chip of the present invention.

FIG. 44 shows a fluorescence scanner image of a multiplex PCR product of a sample resistant to tetracycline and β-lactam antibiotics and including TEM, TetM and AmpC genes, obtained with the DNA chip of the present invention.

### MODE FOR INVENTION

The examples and experiments will now be described. The following examples and experiments are for illustrative purposes only and not intended to limit the scope of this disclosure.

### Example 1

### Design of PCR Primer

The success in amplification of nucleic acids, especially by PCR, depends on whether a primer specifically anneals only with its target sequence. Whether a primer specifically anneals only with its complete complement or it anneals also with other nucleotide sequences with one or more mismatch(es) depends on annealing temperature.

In general, at higher annealing temperature, the possibility of specific annealing with a perfectly matching template increases. Therefore, the odds of amplification of the target sequence increases. In contrast, at lower annealing temperature, amplification of non-target sequences increases as mismatch tolerance increases. Thus, by controlling the annealing temperature, the pairing characteristics between the template and the primer may be varied. For example, if a product is formed in a control group having only one primer, it means that the primer anneals with more than one site of the template. In that case, it is recommended to raise the annealing temperature. Considering such an effect of annealing temperature on the annealing specificity of the primer, an annealing regulating primer system capable of controlling the primer annealing through the annealing temperature and, thereby, improving annealing specificity of the primer regardless of the primer design is strongly demanded.

Accordingly, the inventors have determined gene region to be assayed for the genes of 14 STD-causing microorganisms and antibiotic resistance genes and designed combinations of oligonucleotide primers needed to amplify them by PCR, as shown in Table 2.

TABLE 2

| Target microorganism | SEQ ID | Gene Bank | Base sequence | Length |
|---|---|---|---|---|
| (Target gene) | No. | No. | (5′-3′) | (bp) |
| Gardnerella vaginalis | 1 | L08167 | GTTGGATGCCTTGGTAGA | 419 |
| (3′ end of 16S rRNA, | 2 | | GCTACTTGGGAATAAACATAAAA | |
| spacer, [symbol] 5′ end of 23S | | | | |
| rRNA gene) | | | | |
| Ureaplasma urealvticum | 3 | M36190 | AGCAATTAACTTCGCTGAAGGC | 373 |
| (U reB gene) | 4 | | TAAACATAATGTTCCCCTTCGTC | |
| Mycoplasma hominis | 5 | AJO02268 | AATGGCTAATGCCGGATACGC | 333 |
| (16S rRNA-rrnA operon) | 6 | | GTACCGTCAGTCTGCAATCAT | |
| Chlamydia trachomatis | 7 | AM886279 | TAATAGTGGCAACTAGAACTCGATGGAC | 321 |
| (Cryptic plasmid | 8 | | CTGCTGTAATCACCCAGTCGATAAAT | |
| DNA pUCH1) | | | | |
| Neisseria gonorrhoeae | 9 | M10316 | GCTCGCTTTGCTTCAATGC | 284 |
| (Cryptic plasmid pJD1) | 10 | | GCCCTATCAGGCAAGCTAAA | |
| Trichomonas vaginalis | 11 | XM001579 | ATTGTCGAACATTGGTCTTACCCTC | 262 |
| (repeated DNA target) | 12 | | TCTGTGCCGTCTTCAAGTATGC | |
| Mycoplasma genitalium | 13 | L43967 | GCATTGGAAACTATCAGTCTAGAG | 207 |
| (16S rRNA gene) | 14 | | GCTCCGACAGCTAGTATCTATCG | |
| Candida albicans | 15 | EF56810 | TACGACTTGGGTTTGCTTGA | 148 |
| (18S rRNA gene) | 16 | | GCGGGTAGTCCTACCTGATTT | |
| Coli Form | 17 | EU236406 | TCCTACGGGAGGCAGCAGT | 467 |
| (16S rRNA gene) | 18 | | GGACTACCAGGGTATCTAATCCTGTT | |
| Haemophilus ducreyi | 19 | AY513483 | CAAGTCGAACGGTAGCACGAAG | 439 |
| (16S rRNA gene) | 20 | | TTCTGTGACTAACGTCAATCAATTTTG | |
| HSVu (secreted portion of | 21 | EU018121 | AACGCCGCCATGTTCGC | 350 |
| glycoprotein G-2 (US4 )) | 22 | | CGCTCCATGGCCGACAC | |
| Treponema pallidum | 23 | AE000520 | GAAGTTTGTCCCAGTTGCGGTT | 260 |
| (47 kDa antigen gene | 24 | | CAGAGCCATCAGCCCTTTTCA | |
| (integral membrane | | | | |
| lipoprotein)) | | | | |
| HPV (L1) | 25 | NC_001526 | GCMCAGGGWCATAAYAATGG | 191 |
| | 26 | | TTTTTTAATAAACTGTAAATCATATTCCTC | |
| SHV | 27 | AY008838 | CTTTCCCATGATGAGCACCT | 679 |
| (beta- lactamase SHV-12) | 28 | | TAGCGTTGCCAGTGCTCG | |
| TEM | 29 | EF534736 | GAGGACCGAAGGAGCTAACC | 412 |
| (CMT- type beta tactamase) | 30 | | ATCTCAGCGATCTGTCTAT | |
| TetM (transposon T n916 | 31 | EF016118 | ACACGCCAGGACATATGGAT | 291 |
| tetracycline resistant gene) | 32 | | CGGTAAAGTTCGTCACACAC | |
| AmpC | 33 | DQ432012 | GGTTCGGTCAGCAAAACATT | 208 |
| (ceobalospolimse gene) | 34 | | GCAAGTCCCTTGAGGATTTC | |
| TetC | 35 | AB089597 | GCTTCCTAATGCAGGAGTCG | 152 |
| (tetracycline resistant | 36 | | GGCACCTGTCCTACGAGTTG | |
| gene) | | | | |

(M means A or C; W means A or T; and Y means C or T.)

The gene region to be assayed was selected primarily from 16S rRNA or 23S rRNA, or the middle of them, and the space intergenic region, which are most widely used for identification of the phylogeny of microorganisms (Olsen G J et al., Ribosomal RNA: a key to phylogeny. FASEB 1993; 7: 113-123; Lane D J B et al., Proc. Natl. Acad. Sci. USA. 1985; 92: 6955-9).

As a standard for PCR amplification region, the common base sequence in all microorganisms and microorganisms of the same genus, so-called highly conserved region, was placed at 5′ end, and the unique base sequence in species (genus) of the target microorganism was placed at the other end. If there is no suitable base sequence on 16S rRNA or 23S rRNA or in the region between 16S and 23S, the unique gene and unique base sequences of the target microorganism are selected in other regions for assay. For example, since 16S rRNA of Neisseria gonorrhoeae is similar to that of Neisseria meningitides by 98% or more, it is very difficult to detect Neisseria gonorrhoeae from a clinical sample only by PCR using a primer specific to the 16S rRNA gene. Actually, when PCR and DNA base sequencing were carried out by the inventors of the present invention for clinical samples suspected of infection by Neisseria gonorrhoeae, Neisseria meningitides, not Neisseria gonorrhoeae, was detected in about 8% of them. Therefore, in the present invention, a primer binding specifically to the cryptic plasmid pJD1 of Neisseria gonorrhoeae was used, instead of a primer binding specifically to 16S rRNA of Neisseria gonorrhoeae to avoid false positive.

16S rRNA's of Ureaplasma urealyticum and Ureaplasma parvum have 99% or more similarity. Thus, as in Neisseria gonorrhoeae, when a primer binding specifically to 16S rRNA of Ureaplasma urealyticum, it is difficult to selectively distinguish Ureaplasma urealyticum from Ureaplasma parvum. Therefore, in the present invention, a primer binding specifically to UreB gene was used.

16S rRNA of Chlamydia trachomatis has similarity of 98%, 97% and 95% to Chlamydia muridarum, Chlamydia suis and Chlamydophila caviae of the same genus, respectively. In order to specifically detect Chlamydia trachomatis, a primer binding specifically to the cryptic plasmid pUCH1 of Chlamydia trachomatis was used.

Although 16S rRNA's of Mycoplasma hominis and Mycoplasma genitalium have relatively small similarity of 75%. If a primer binding specifically to the conserved region is used, M. hominis and M. genitalium can be distinguishably detected, but bacteria of the Ureaplasma may be falsely detected. Therefore, a primer binding specifically to the non-conserved region was used.

### Example 2

### Securement of Control Microorganism and Sample and Clone Thereof

The strains of the 14 STD-causing microorganisms of standard positive control group and DNAs of antibiotic resistance genes were purchased from ATCC (Manassas, Va. 20108, USA, and also, a sample which had been identified to be already infected with each microorganism and a sample including antibiotic resistance genes were obtained. DNA was isolated therefrom, and then the target gene region to be assayed was amplified by PCR for each microorganism and identified through cloning and sequencing. Plasmid clone was secured for each of them.

The cloning experiment was performed by the publicly known method as follows. The method for PCR is the same in following examples, so the description thereof is skipped here.

1) The PCR products of the genes of the 14 STD-causing microorganisms and the PCR product of human beta-globin gene were isolated on the agarose gel using a gel recovery kit (Zymo Research, USA), and the concentrations were measured using a spectrophotometer or by densitometry of the agarose gel.

2) pGEM-T Easy Vector (Promega, A1360, USA) and 2× Rapid Ligation Buffer, which had been kept as frozen, were melt and mixed by shaking the tube lightly with finger ends, and lightly centrifuged, whereby ligation reaction was performed in a 0.5 mL tube in the ratio shown in Table 3 with the insertion of the DNA to be cloned.

TABLE 3
Composition of ligation reaction

| | Standard | | | |
|---|---|---|---|---|
| | reaction | | Positive | Background |
| | solution | | control | control |
| 2x Rapid Ligation Buffer, T4 DNA | 5 | μL | 5 μL | 5 μL |
| ligase | | | | |
| pGEM-T Easy Vector (50 ng/μL) | 1 | μL | 1 μL | 1 μL |
| PCR product | X | μL* | — | — |
| Inserted DNA | — | | 2 μL | — |
| T4 DNA ligase (3 Wess units) | 1 | μL | 1 μL | 1 μL |
| Final volume (adjusted by addition | 10 | μL | 10 μL | 10 μL |
| of deionized water) | | | | |

*The ratio of the PCR product to the vector is adjusted to 3:1. That is, in case 50 ng of 3.0 kb vector is ligated with 0.25 kb and 0.45 kb DNAs, the DNAs are inserted in amounts of 12.4 ng and 22.5 ng, respectively.

3) Each reaction solution was mixed well with a pipette, and held for ligation at room temperature for about an hour. If a lot of transformants are needed, it may be held for reaction at 4° C. overnight.

4) The ligated sample was subjected to transformation using 50 μL of JM109 competent cells (=1×10⁸ cfu/μg DNA), which had been kept at −70° C.

5) First, 2 μL of the ligation product (ligate) obtained above was added to a 1.5 mL tube, 50 μL of the competent cells, which had been thawed immediately before, was added again thereto, and the mixture was mixed well, and then held for reaction in an ice bath for 20 minutes.

6) The cells were put into a 42° C. circulating water bath, and treated with heat shock for 45 to 50 seconds. Immediately thereafter, they were put again into the ice bath and left for 2 minutes.

7) 950 μL of SOC medium, which was adjusted to room temperature, was added thereto, and cultivation was performed in a shaking incubator at 37° C. for about 1.5 hours.

8) About 100 μL of the culture solution was applied to an LB plate containing ampicillin, IPTG and X-Gal, and then the plate was flipped and cultivation was performed in an incubator adjusted to 37° C. for 16 to 24 hours. Then, colony number was counted (colony counting), and only white colony was selected and cultured in 3 mL LB/ampicillin culture solution, and then plasmid DNA was isolated and purified with DNA mini-prep procedure. Then, it was identified whether the insertion DNA was properly inserted through PCR and cleavage reaction by restriction enzyme. The base sequence of thus obtained clone was assayed using an automated sequencer.

Characteristics of the positive control microorganisms and secured plasmid clones are summarized in Table 4.

TABLE 4
Positive control microorganisms and plasmid clones

| | Positive control | |
|---|---|---|
| Microorganisms | (ATCC No.) | Clone |
| N. gonorrhoeae | 53420D | Plasmid pJD1 |
| C. trachomatis | VR-879 ™ | Cryptic plasmid |
| U. urealyticum | 27618 | UreB gene |
| M. genitalium | 33530D | 16S rRNA gene |
| T. vaginalis | 30001D | Repeated DNA target |
| H. ducreyi | 700724D | 16S rRNA gene |
| M. hominis | 23114D | 16S rRNA-rrnA operon |
| G. vaginalis | 49145D | 16S-23S rRNA |
| T. pallidum | 632625 | Carboxypeptidase gene |
| HSV | VR-733 ™ (HSV1) | Secreted portion of |
| | VR-540 ™ (HSV2) | glycoprotein G-2 (US4) |
| C. albicans | 102312D-5 | 18S rRNA gene |
| HPV | HPV 6 (45150) | HPV whole genome |
| | HPV 11 (45151) | |
| | HPV 16 (45113) | |
| | HPV 18 (45152) | |

### Example 3

### Gathering of Clinical Sample

A suitable method was established for gathering from a human body various samples such as discharge from the urethra, cervix or mouth, a swab sample which is obtained by gathering cells with a cotton swab or brush, the urine, urethral washing solution and the prostate solution, and carrying and storing them before an assay. Gathering of the male urine was performed in division of VB (voided bladder) 1, VB2 and VB3 expressed prostatic secretion (EPS) according to the traditional 3-glass test. VB1 refers to the 10 to 20 mL urine which comes first in urination, i.e., early stream urine. VB2 refers to mid-stream urine which comes in the middle of urination. The EPS refers to secretion which comes to the urethra following the prostate massage. VB3 refers to the 10 to 20 mL urine which comes first in urination following the prostate massage. Herein, VB1 represents a urethra sample, VB2 represents a bladder sample, and VB3 represents a prostate sample.

The method of gathering samples, tools used therefore and the method of carrying and storing the samples were as follows. In this STD assay, the standard samples for males were a swab sample of the urethra or the early stream urine (VB1), and if necessary, the urethral discharge or the urine after the prostate massage (VB3) were added. Meanwhile, the standard samples for females were a swab or scrape sample of the cervix, and if necessary, a swab sample or discharge of the vagina or the urine were added. In case of gay or prostitute, samples may be further obtained from the rectum, anus or mouth.

In obtaining a swab sample of the urethra from a male, a sterilized cotton swab with cotton or brush attached on the tip was inserted into 2 to 3 cm inside of the urethral meatus, and moved to the left and the right to thereby collect the discharge and cells in the urethra. And, in obtaining a swab sample of the cervix from a female, a sterilized cotton swab with cotton or brush attached on the tip was inserted into the cervix and moved to the left and the right to thereby collect the discharge and the cells. Herein, as the tool for gathering the swab sample, a cotton swab from Copan innovation (USA) or a Pap-brush from Sang-A Medical (Seoul, Korea) or an equivalent product thereof is used. Then, the cotton portion or brush portion of the cotton swab was put into a tube, which had sterilized sample storage solution inside, and had a screw cap for transportation and storage.

The gathered sample such as the urine or the swab sample should be carried within 48 hours to the laboratory if possible, and should be kept at refrigerating temperature during transportation. This helps to isolation of microorganisms, which are stringent for gene application, and inhibits overgrowth of fast-growing microorganisms.

A sterilized sample storage solution was filled in advance in the sample gathering tube. The composition was 100 mL of 37% to 40% formaldehyde mixed with 15 mL of methanol, 6.5 g of Na₂HPO₄ and 4.0 g of NaH₂PO₄, and triply distilled water added thereto make a final volume of 1 L.

In case of the urine sample, 10 to 20 mL of fresh urine, which had been gathered by the method described above, was added to a sterilized 30 mL tube with a screw cap, moved and stored at 4° C. before the assay. Alternatively, it was centrifuged to give cell precipitate layer, which was stored at −70° C. and later was subjected to DNA isolation.

### Example 4

### Isolation of DNA

DNA was isolated and purified as follows using a commercialized kit and various human samples of Example 3.

Urine Sample

Urine was put in a 50 mL conical tube and centrifuged at 3,000 rpm for 30 minutes. The supernatant was discarded and the pellet was resuspended in 200 to 500 μL of PBS, and then the suspension was transferred to a 1.5 mL microcentrifuge tube. After centrifuge for 2 minutes, the following procedure was carried out.

Vaginal Swab, Urethral Barbotage, Urethral Swab, EPS, Urethral Discharge or Semen Sample

0.8 mL of gathered sample was transferred to a 1.5 mL tube. After mounting the tube in a microcentrifuge, centrifuge was performed at 12,000 rpm for 2 minutes. The supernatant was discarded and 500 μL of 1×PBS was added. The cells were mixed well with the solution by vortexing. After centrifuging at 12,000 rpm for 2 minutes, the supernatant was removed and 200 μL of buffer TL was added. After adding 20 μL of protease K, the mixture was mixed well by vortexing and reacted for 30 minutes in a constant-temperature bath at 56° C. Upon completion of the reaction, the tube was spun down at 8,000 rpm or above for about 10 seconds to collect the solution adhering to the cap. After adding 400 μL of buffer TB, the mixture was mixed well. Then, the solution adhering to the cap was collected by spinning down at 8,000 rpm or above for about 10 seconds. The reaction solution was transferred to a spin column integrated to a collection tube. After centrifuge at 8,000 rpm for 1 minute, the filtrate was discarded and a new collection tube was integrated. After adding 700 μL of buffer BW, centrifuge was performed at 8,000 rpm for 1 minute. The filtrate was discarded and a new collection tube was integrated. After adding 500 μL of buffer NW, centrifuge was performed at 12,000 rpm for 3 minutes. The filtrate was discarded and a new 1.5 mL was integrated. 200 μL of buffer AE or sterilized water was fed into the column. After keeping at room temperature for 2 minutes, centrifuge was performed at 8,000 rpm for 1 minute. The extracted genomic DNA may be immediately subjected to PCR or may be stored at −20° C. before use. The extracted genomic DNA may be identified under UV after electrophoresis on 0.8% agarose gel. In case where the DNA concentration of about 20 ng/μL was obtained, 3 μL of the isolated DNA was used in PCR, and in the case where the DNA band was not seen on 3% agarose gel, 6 μL thereof was used.

### Example 5

### PCR for Establishing Conditions of Single PCR

Artificial samples were made by adding plasmid clones of target genes, which were obtained in Example 2 for testing on each microorganism in multiple copies of 10, 100, 1,000 and 10,000, to sterilized triply distilled water, a sample storage solution of Example 3 and fresh urine (VB1) of a normal male without symptoms of infection. Then, single PCR on target genes for each microorganism was preformed repeatedly, thereby establishing conditions for the single PCR. When performing PCR, PCR of human beta-globin gene, which was an internal reference gene, was performed together. Moreover, in consideration of multiplex PCR afterwards, it was designed such that the size of each PCR product was distinctively different from each other, but that the annealing temperature had no big difference.

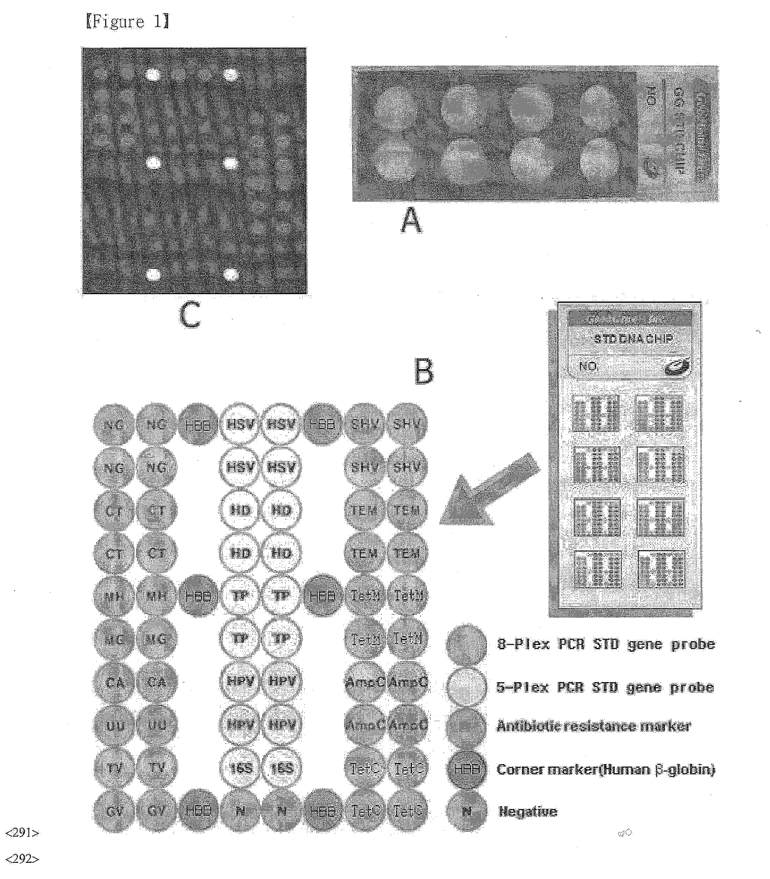

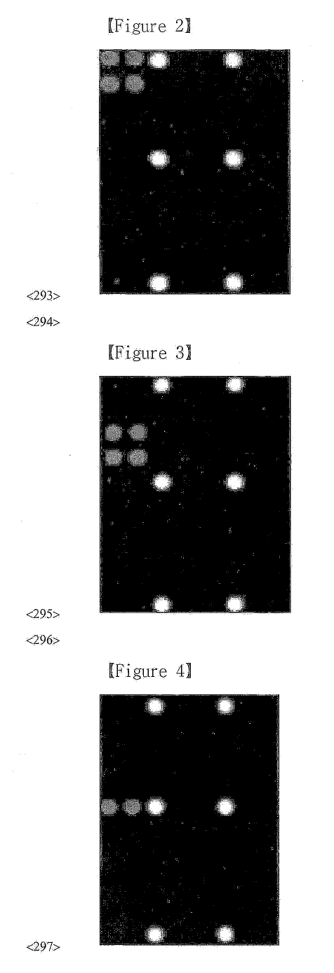

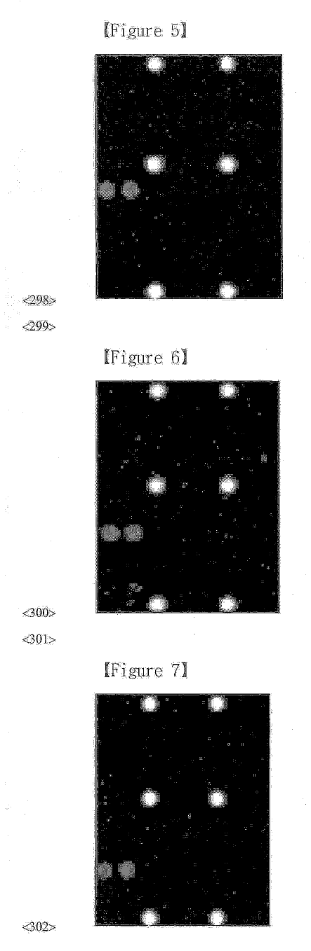

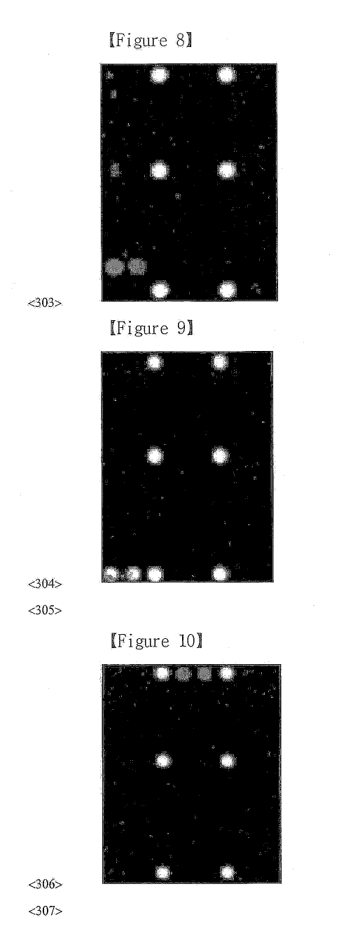

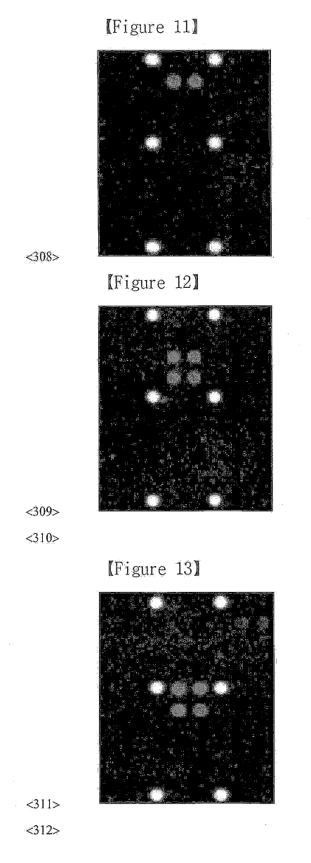

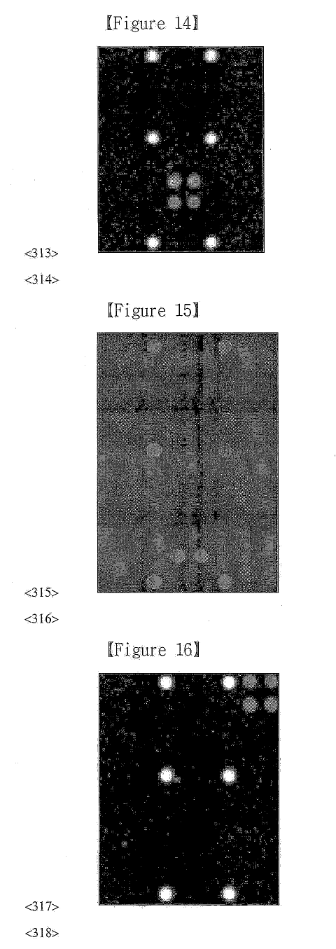

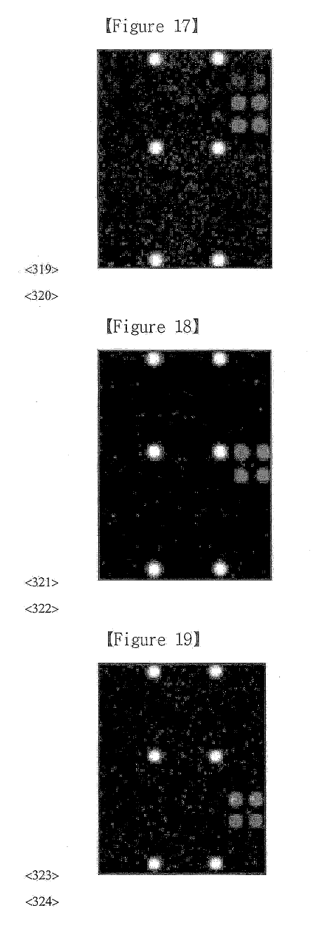

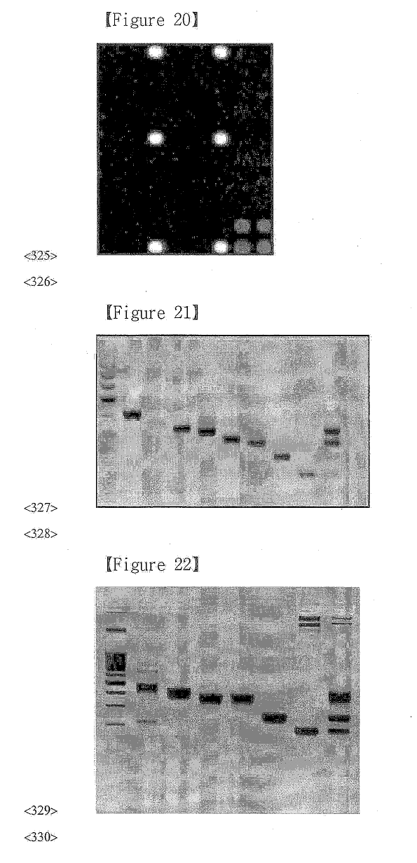

When the primer designed in the present invention is used, detection is always possible as long as 10 to 100 copies of plasmid clones are included in 1 mL of sample solution. After performing PCR, the product was identified by subjecting to electrophoresis on 3% agarose gel, and the results are shown in FIGS. 1 to 5.

The composition and conditions for PCR are summarized in Table 5.

TABLE 5
Composition and conditions for single
PCR of 14 STD-causing microorganisms
PCR composition

| ddH₂O | 8 | μL |
|---|---|---|
| 2x MM Premix | 15 | μL |
| Forward & reverse primers (5 pmol/μL) each | 2 μL, 2 μL | |
| Template DNA (>20 ng) | 3 | μL |
| Final volume | 30 | μL |

PCR conditions

| Predenaturation | 94° C./10 min | 1 | cycle |
|---|---|---|---|
| Denaturation | 94° C./30 sec | 40 | cycles |
| Annealing | 58° C./30 sec | | |
| Extension | 72° C./30 sec | | |
| Final extension | 72° C./5 min | 1 | cycle |

### Example 6

### Single PCR on Clinical Sample

From 541 adult male and female patients who had visited the department of urology and the department of obstetrics and gynecology of Korean hospitals with suspicion of contraction of STD and 103 adult males and females without symptoms of sexually transmitted infection, various samples such as VB1, urethral swab, cervical swab, and the like were collected via the method of Example 3. Then, DNA was isolated according to the method of Example 4, and single PCR was performed according to Example 5.

### Example 7

### Sequencing of PCR Products of Clinical Sample

The PCR products of Example 6 were subjected to sequencing reaction using ABI Prism BigDye Terminator Cycle Sequencing Ready Reaction kit version 1.1 (Perkin Elmer Biosystems, USA), and then subjected to base sequencing using ABI 3130x1 automated sequencer (Perkin Elmer, USA). These procedures were carried out in the following order.

(1) In order to use the PCR products obtained from each sample as main substance in the sequencing reaction, the most suitable concentration was adjusted. For example, if the product is 100 to 200 by long, a concentration of 1 to 3 ng/μL is needed, and if it is 200 to 500 by long, about 3-10 ng/μL is needed.

(2) 1 μL of each PCR product, 2 pmol of primer and 8 μL of dye terminator ready reaction mix were fed into a thin wall microcentrifuge tube, and sterilized distilled water was added thereto so that the final volume was 10 μL. Then, the mixture was mixed well by light agitation.

(3) The mixture of (2) was subjected to cycle sequencing reaction using GeneAmp 2700 (PE Biosystems, USA) with a total of 25 cycles, in which each cycle was 10 seconds at 96° C., 5 seconds at 50° C. and 4 minutes at 60° C.

(4) The obtained PCR product was added to 62 μL of PPT solution (absolute EtOH 250 mL, 3 M NaOAc 10 mL, DW 50 mL) in a 1.5 mL microtube. After mixing well by vortexing, followed by keeping at −20° C. for 15 minutes, centrifuge was performed at 14° C. and at 13,000 rpm for 5 minutes to precipitate only the fluorescence-labeled DNA. After carefully removing the supernatant and adding 170 μL of cleaning solution (70% EtOH), centrifuge was performed again. After removing the supernatant and the salt, the product was dried on a 60° C. heat block for about 3 minutes.

(5) 10.1 μL of Hi-Di was added to the DNA obtained in (4) and mixed by vortexing for 30 to 60 seconds. 10 μL in the middle was put in a new 0.2 mL strip PCR tube and prepared by reacting at 95° C. for 2 minutes and at 4° C. for about 3 minutes.

(6) The denatured DNA of (5) was charged to each well of a plate that had been cast, subjected to electrophoresis for 2 to 4 hours, and then base sequence was analyzed using ABI 3130x1 sequencer.

From the sequencing assay, the appropriateness of the single PCR for detecting the 14 STD-causing microorganisms and the antibiotic resistance genes was confirmed, and as a result, the database on molecular epidemiology and genotyping of the 14 STD-causing microorganisms was established for Koreans. The sample identified as infected by STD through PCR and sequencing was then used for multiplex PCR and for evaluation of the DNA chip.

### Example 8

### Establishment of Conditions for Multiplex PCR

Artificial samples were made by adding plasmid clones of specific genes comprising one to four types, which were obtained in Example 2 for testing on each microorganism in multiple copies of 10, 100, 1,000 and 10,000, to sterilized triply distilled water, a sample storage solution of Example 3 and fresh urine (VB1) of a normal male without symptoms of STD. Then, multiplex PCR was preformed simultaneously by adding the primers of target genes for the 14 STD-causing microorganisms and antibiotic resistance genes in one tube.

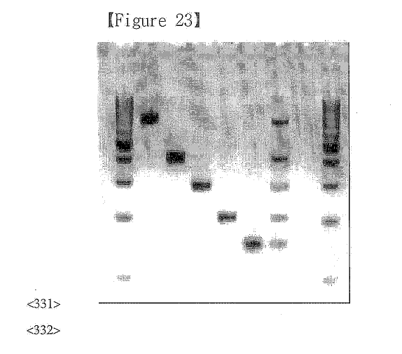

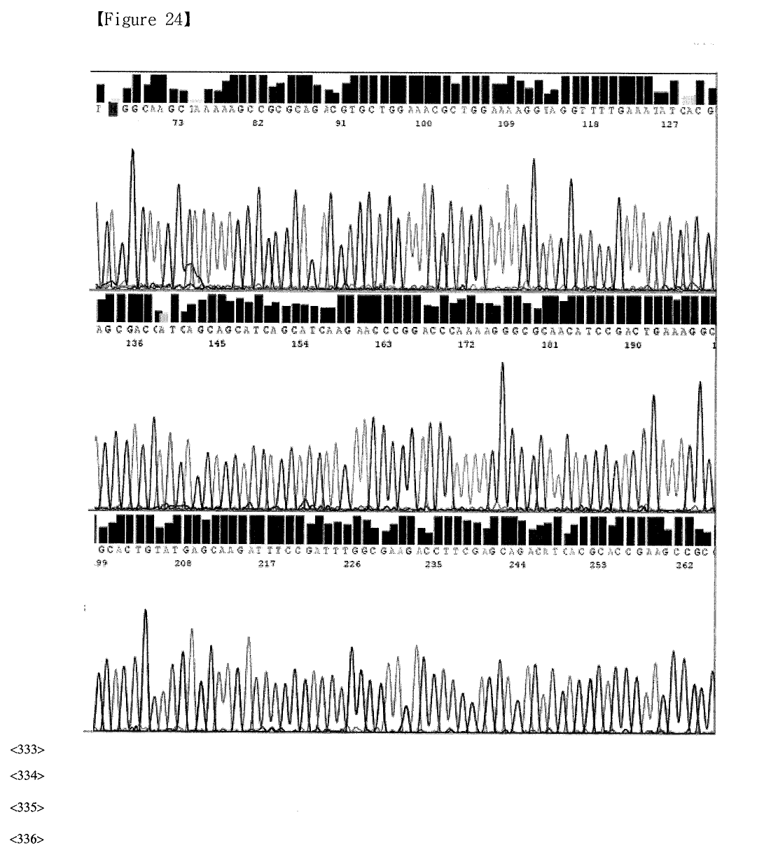

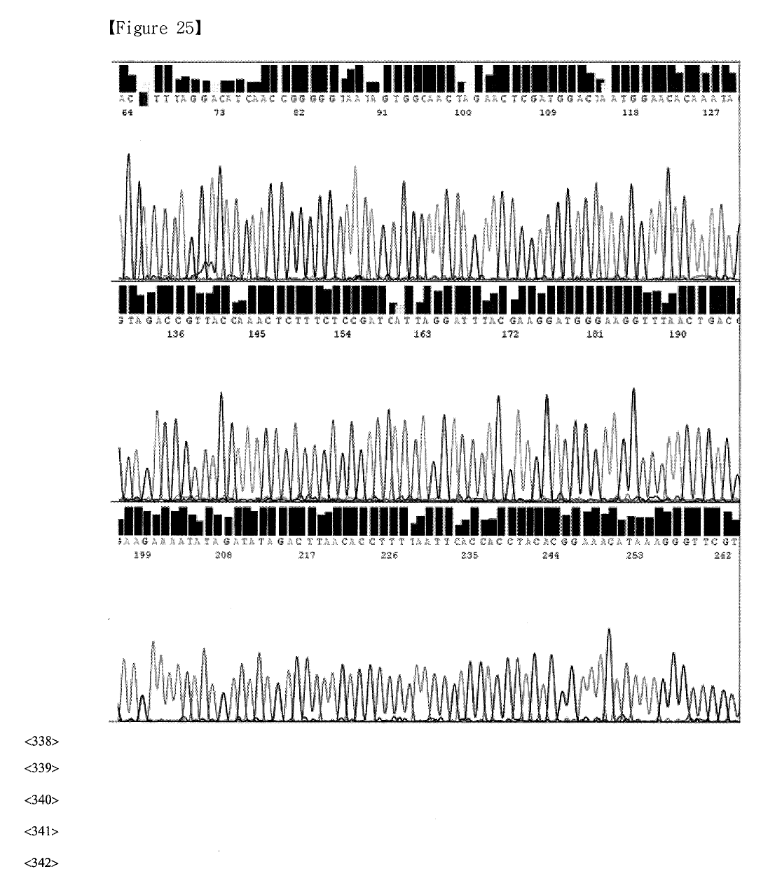

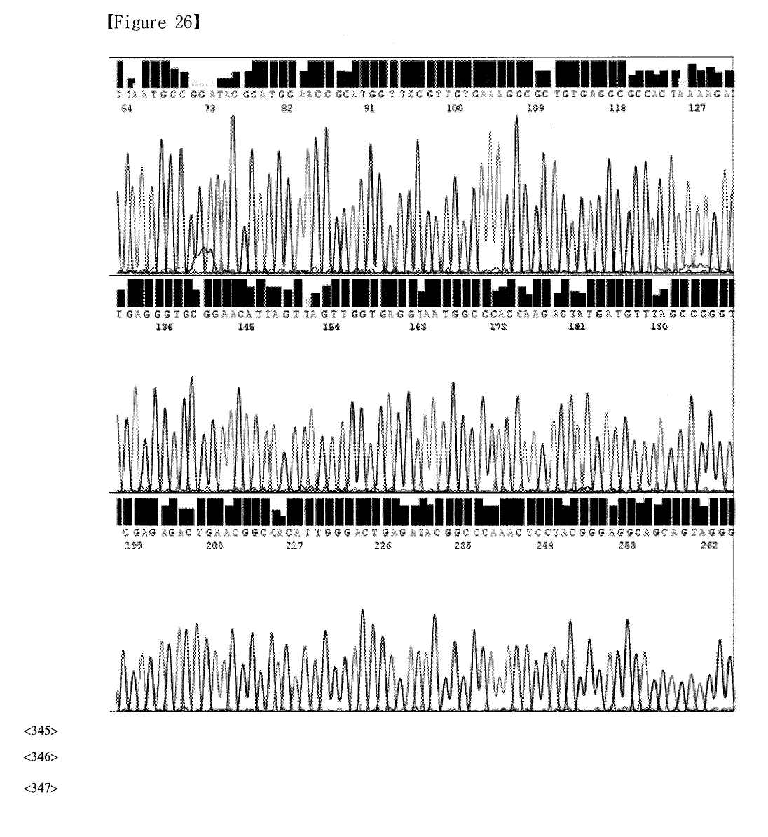

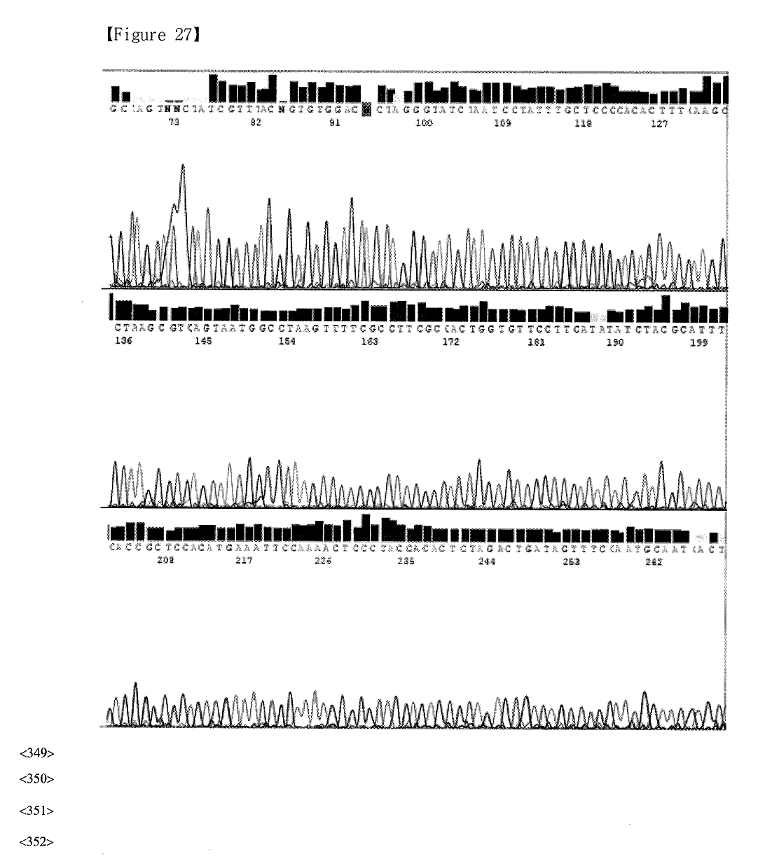

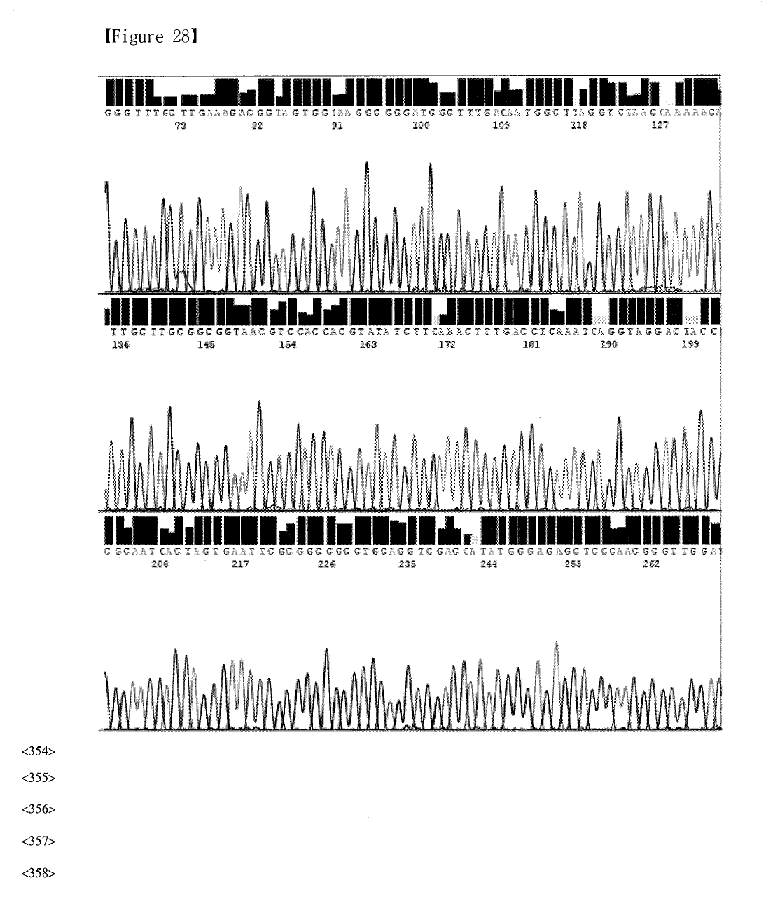

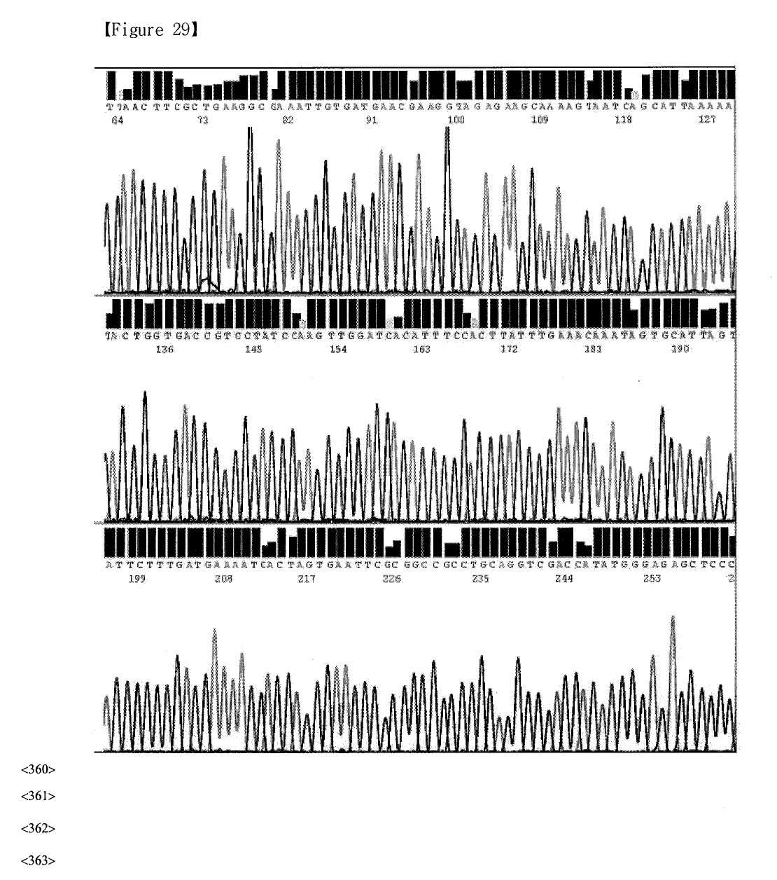

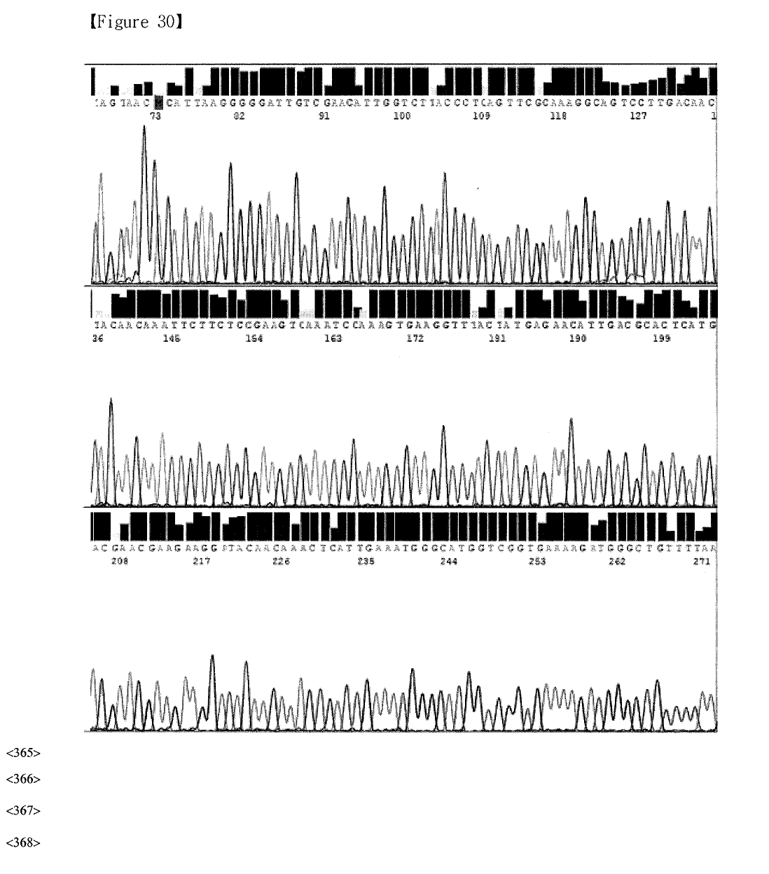

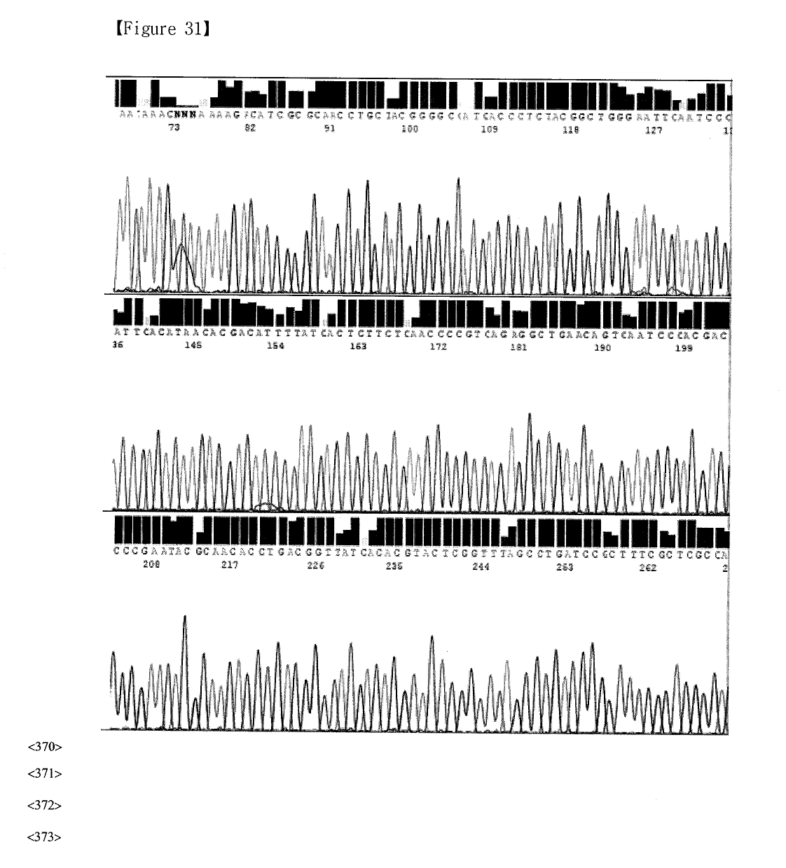

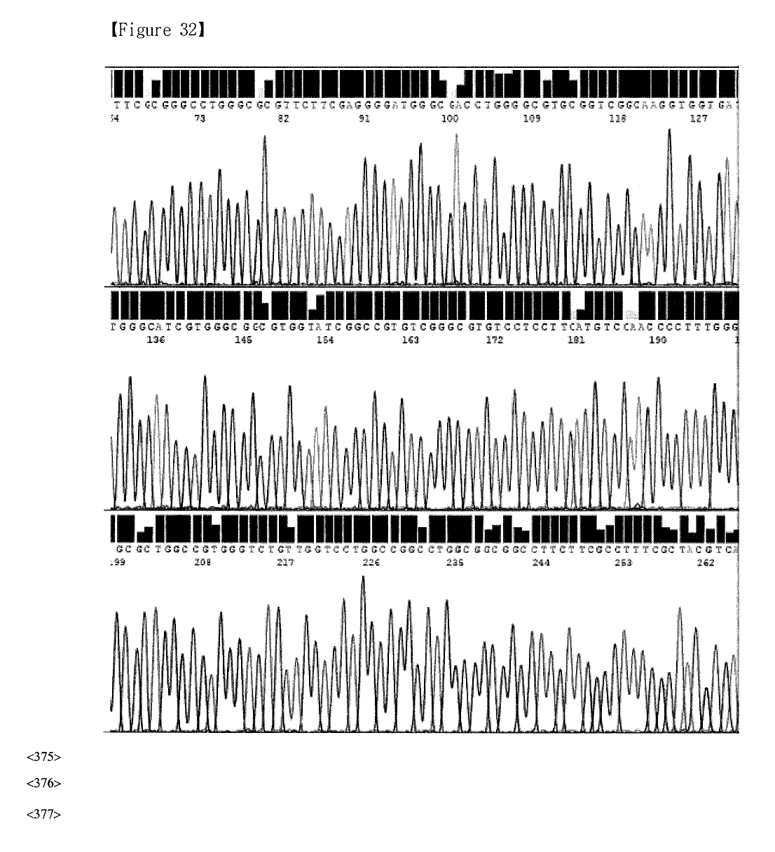

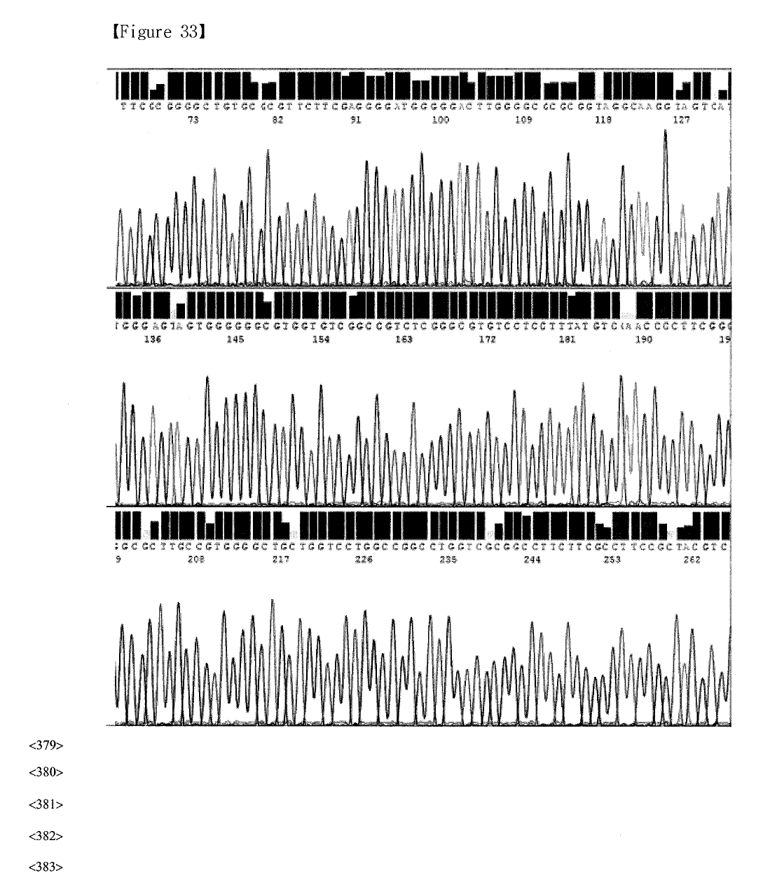

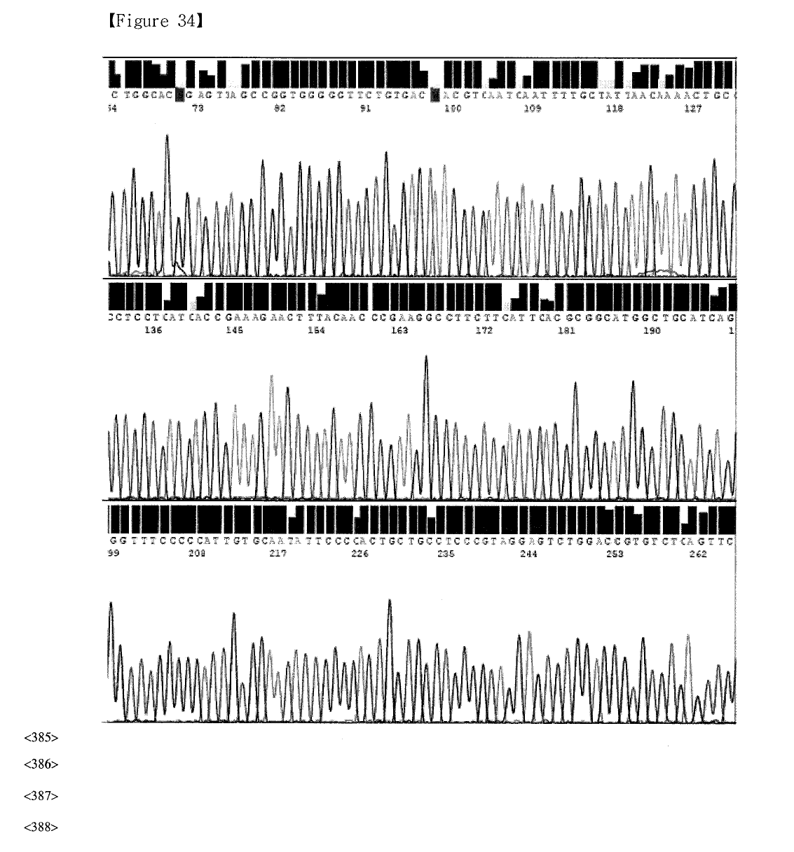

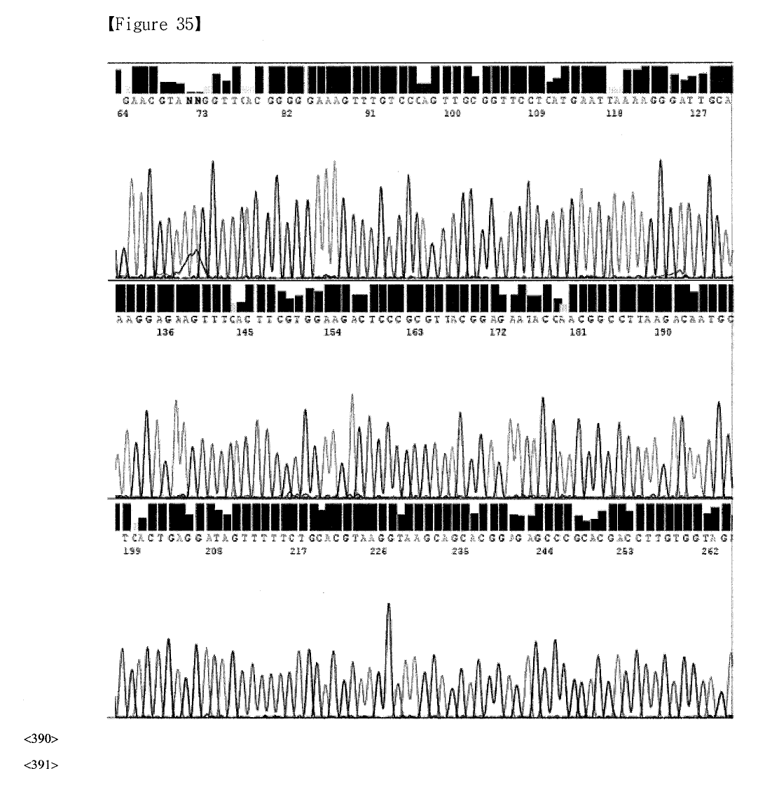

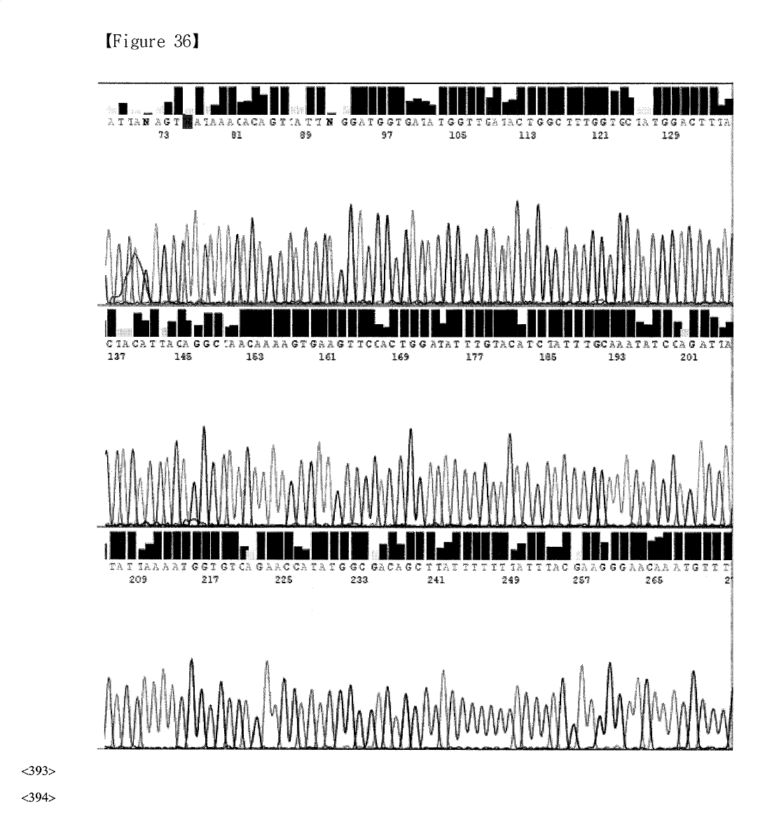

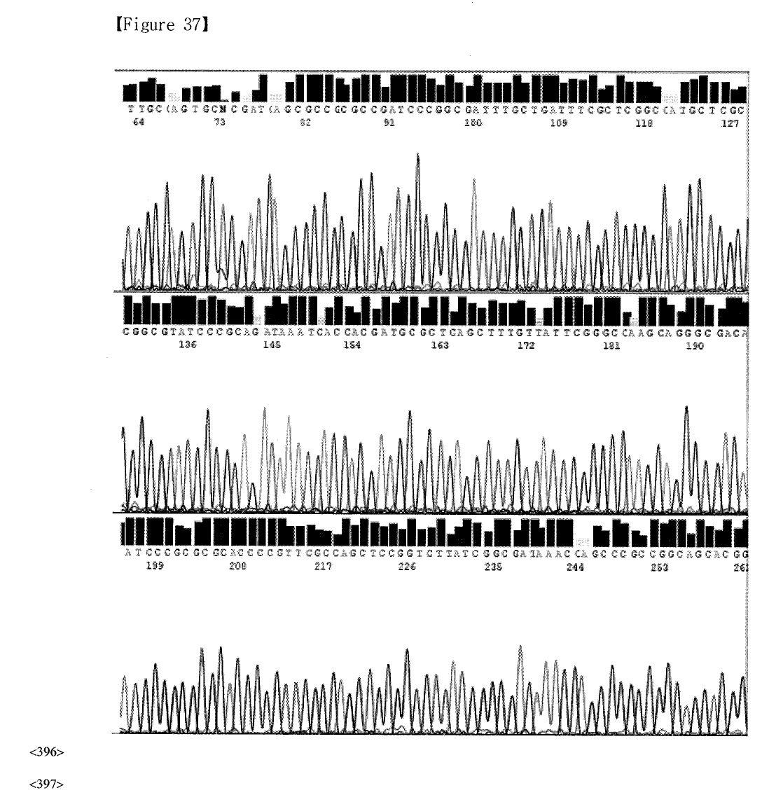

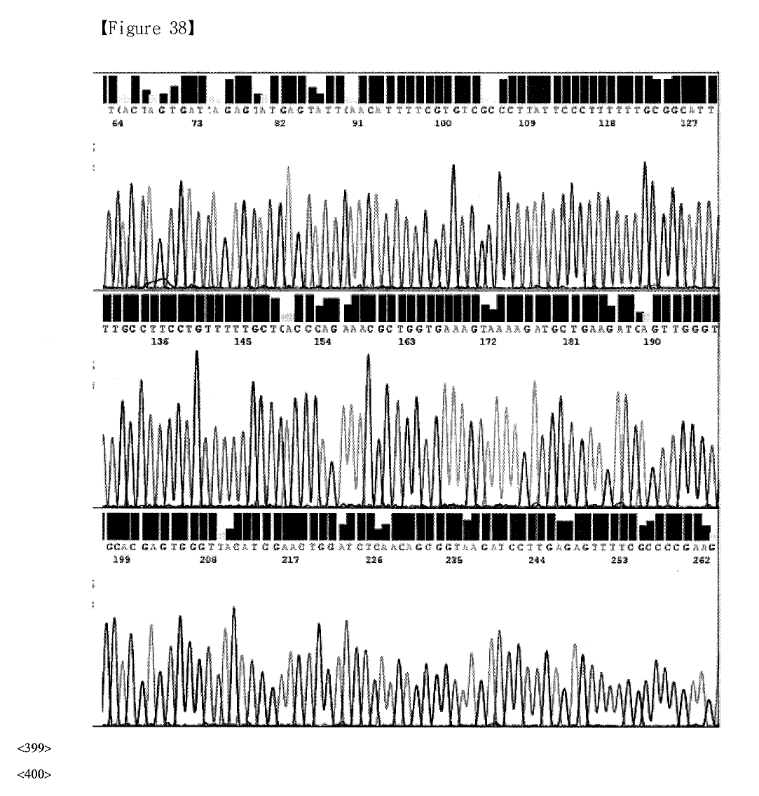

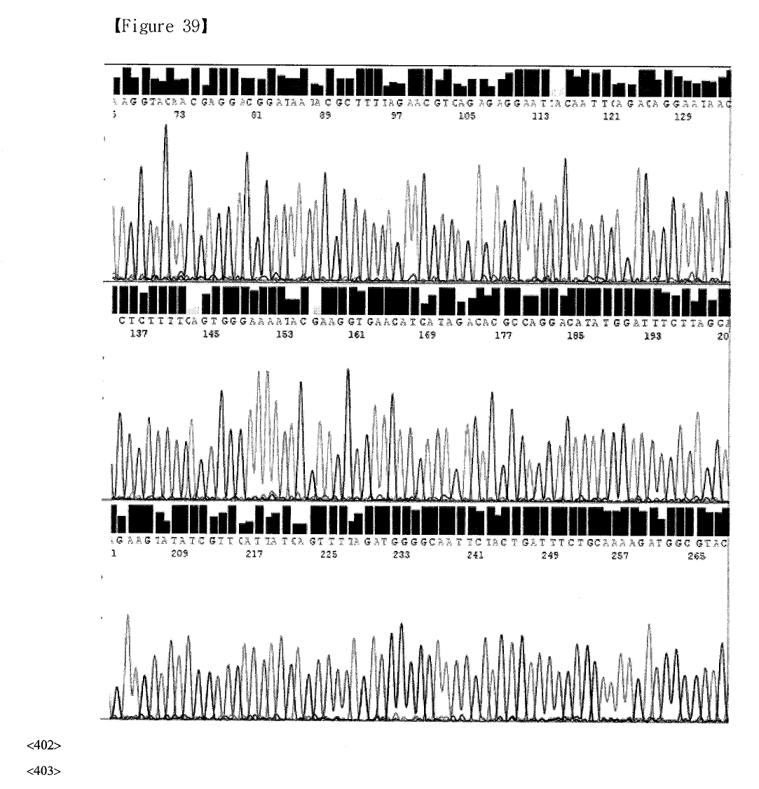

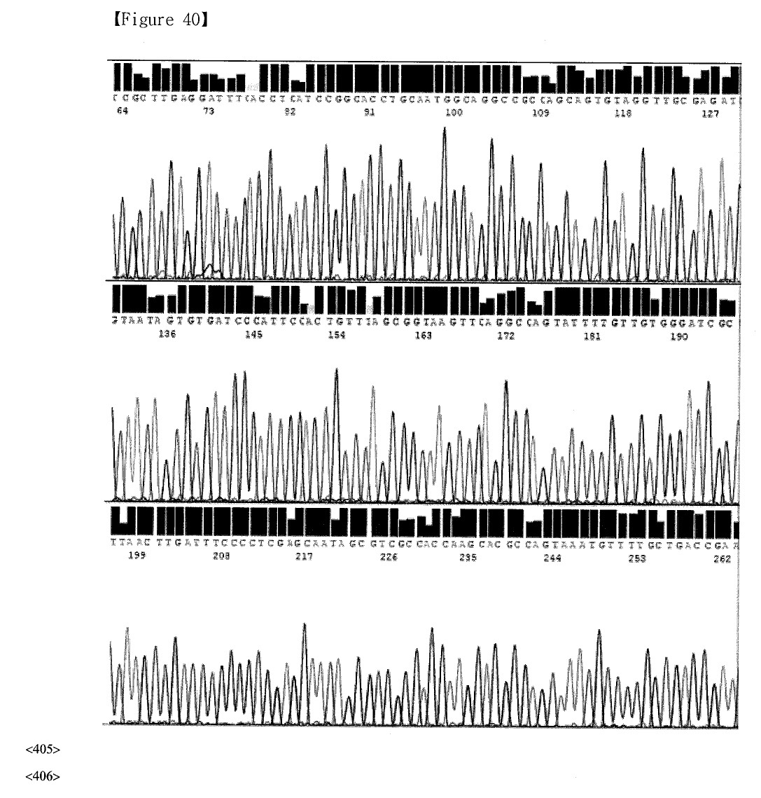

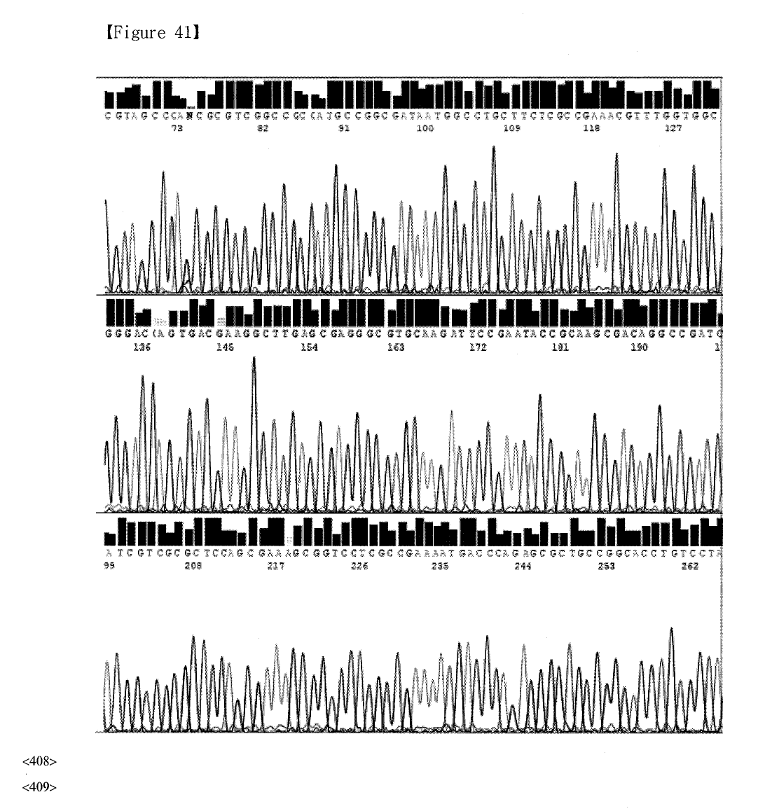

The compositions and conditions for the multiplex PCR are summarized in Tables 6, 7, 8 and 9. After the multiplex PCR, the product was identified by electrophoresis on 1.5 to 2.0% agarose gel (FIGS. 21 to 23). Seeing the electrophoresis images of the PCR products, in FIG. 21 (Set A, 8-plex), the PCR product of Gardnerella vaginalis is 419 bp, the PCR product of Ureaplasma urealyticum is 373 bp, the PCR product of Mycoplasma hominis is 333 bp, the PCR product of Chlamydia trachomatis is 321 bp, the PCR product of Neisseria gonorrhoeae is 284 bp, the PCR product of Trichomonas vaginalis is 262 bp, the PCR product of Mycoplasma genitalium is 207 bp, and the PCR product of Candida albicans is 148 bp, respectively. And, in FIG. 22 (Set B, 5-plex), the PCR product of 16S rRNA of coliform bacteria is 467 bp, the PCR product of Haemophilus ducreyi is 439 bp, the PCR product of HSV is 350 bp, the PCR product of Treponema pallidum is 260 bp, and the PCR product of HPV is 191 bp, respectively. With the method of the present invention, the DNAs of the 14 STD-causing microorganisms could be detected accurately through a multiplex PCR at once. In FIG. 23 (Set C, 5-plex), it can be seen that the PCR product of the primer set for amplifying SHV is 679 bp, the PCR product of the primer set for amplifying TEM is 412 bp, the PCR product of the primer set for amplifying TetM is 29 1 bp, the PCR product of the primer set for amplifying AmpC is 208 bp, and the PCR product of the primer set for amplifying TetC is 152 bp, respectively. With the method of the present invention, the DNAs of various antibiotic resistance genes could be detected accurately through a multiplex PCR at once. At this time, it was always possible to distinguish each DNA as long as 10 to 100 copies of plasmid clones of the gene of the microorganisms different from each other were contained in 1 mL of the sample.

TABLE 6
Multiplex PCR condition for Set A
PCR composition, Set A (8-plex)

| | | |
|---|---|---|
| Distilled water | 3 | μL |
| Set A primer, forward/reverse mixture | 4 | μL |
| 2x MM Premix* | 15 | μL |
| 0.05 nM Cy5-dCTP** | 2 | μL |
| Template DNA (>20 ng) | 6 | μL |
| Final volume | 30 | μL |

PCR conditions

| Predenaturation | 94° C./10 min | 1 | cycle |
|---|---|---|---|
| Denaturation | 94° C./30 sec | 40 | cycles |
| Annealing | 58° C./30 sec | | |
| Extension | 72° C./30 sec | | |
| Final extension | 72° C./5 min | 1 | cycle |

*To 1 unit of thermally stable DNA polymerase containing 200 μM dNTPs and 1.5 mM MgCl₂, distilled water was added to make a final volume of 15 mL.
**The ratio of Cy5-dCTP to unlabeled dCTP was 1:12.5.

TABLE 7
Multiplex PCR condition for Set B
PCR composition, Set B (5-plex)

| | | |
|---|---|---|
| Distilled water | 3 | μL |
| Set B primer, forward/reverse mixture | 4 | μL |
| 2x MM Premix* | 15 | μL |
| 0.05 nM Cy5-dCTP** | 2 | μL |
| Template DNA (>20 ng) | 6 | μL |
| Final volume | 30 | μL |

PCR conditions

| Predenaturation | 94° C./10 min | 1 | cycle |
|---|---|---|---|
| Denaturation | 94° C./30 sec | 40 | cycles |
| Annealing | 58° C./30 sec | | |
| Extension | 72° C./30 sec | | |
| Final extension | 72° C./5 min | 1 | cycle |

*To 1 unit of thermally stable DNA polymerase containing 200 μM dNTPs and 1.5 mM MgCl₂, distilled water was added to make a final volume of 15 mL.
**The ratio of Cy5-dCTP to unlabeled dCTP was 1:12.5.

TABLE 8
Multiplex PCR condition for Set C
PCR composition, Set C (5-plex)

| | | |
|---|---|---|
| Distilled water | 3 | μL |
| Set C primer, forward/reverse mixture | 4 | μL |
| 2x MM Premix* | 15 | μL |
| 0.05 nM Cy5-dCTP** | 2 | μL |
| Template DNA (>20 ng) | 6 | μL |
| Final volume | 30 | μL |

PCR conditions

| Predenaturation | 94° C./10 min | 1 | cycle |
|---|---|---|---|
| Denaturation | 94° C./30 sec | 40 | cycles |
| Annealing | 58° C./30 sec | | |
| Extension | 72° C./30 sec | | |
| Final extension | 72° C./5 min | 1 | cycle |

*To 1 unit of thermally stable DNA polymerase containing 200 μM dNTPs and 1.5 mM MgCl₂, distilled water was added to make a final volume of 15 mL.
**The ratio of Cy5-dCTP to unlabeled dCTP was 1:12.5.

TABLE 9
Mixing proportions of Set A, B and C primers
Mixing proportion of Set A primer

| | | | | | | | | | Aver- |
|---|---|---|---|---|---|---|---|---|---|
| | | | | | | | | | age |
| 8-plex | UU | NG | GV | MH | CT | TV | MG | CA | conc. |
| Final conc. | 100 | 100 | 100 | 100 | 100 | 100 | 100 | 100 | 100 |
| (nM) | | | | | | | | | |

Mixing proportion of Set B primer

| | | | | | | Aver- |
|---|---|---|---|---|---|---|
| | 16S | | | | | age |
| 5-plex | rRNA | HD | TP | HSV | HPV | conc. |
| Final conc. | 100 | 100 | 100 | 100 | 100 | 100 |
| (nM) | | | | | | |
| | | | | | | Aver- |
| | | | | | | age |
| Antibiotics | TetM | TetC | TEM | AmpC | SHV | conc. |
| Final conc. | 100 | 100 | 100 | 100 | 100 | 100 |
| (nM) | | | | | | |

(Each 450 μL is added to 10 vials in case of 1,200 tests.)

### Example 9

### Multiplex PCR on Clinical Sample

The DNA of a human sample which had been already identified to be infected by STD by the single PCR and sequencing in Example 7 was subjected to multiplex PCR according to the method established in Example 8.

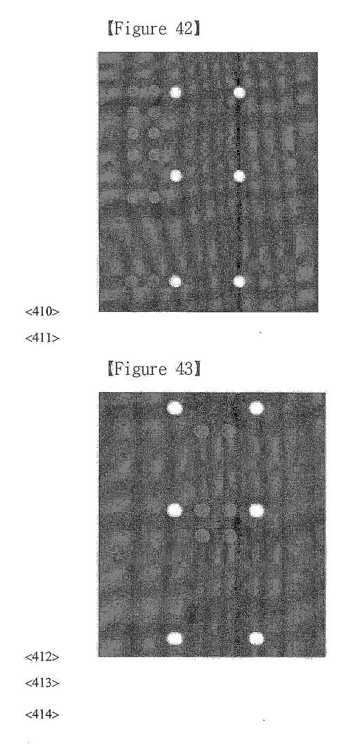

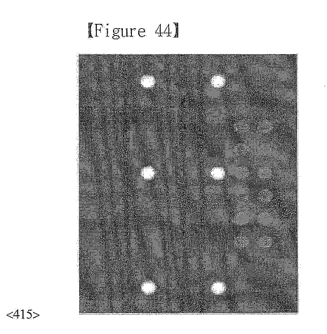

DNA samples included as test subjects were 50 examples of Neisseria gonorrhoeae infected samples, 50 examples of Chlamydia infected samples, 50 examples of Ureaplasma infected samples, 50 examples of Mycoplasma infected samples, 50 examples of Mycoplasma hominis infected samples, 50 examples of Candida albicans infected samples, 50 examples of syphilis infected samples, 1 example of Haemophilus ducreyi infected sample, 50 examples of Trichomonas vaginalis infected samples, 50 examples of Gardnerella vaginalis infected samples, 50 examples of HSV infected samples and 50 examples of HPV infected samples, which had been identified by the single PCR and sequencing, 50 examples of non-infected samples and 50 examples of bacterial prostatitis but not infected by the 14 STD-causing microorganisms as false positive. Among the infected samples, 40 examples of complicated infection were also included. The sensitivity and specificity of the detection of the STD-causing microorganisms were compared between the results of the multiplex PCR and sequencing thereof. Thereby, it was evaluated whether the multiplex PCR and the chip of the present invention could be used in detecting and screening the STD-causing microorganisms, clinically. The results of genotyping for the clinical samples using the chip of the present invention are shown in FIGS. 42 to 44. With respect to the sequencing result following the single PCR, the sensitivity of the multiplex PCR was from 94 to 100%, 98.3% on average, and the specificity was 96%. The diagnosis sensitivity of complicated infection was 97.5%, which was lower than that for single infection.

The results of the multiplex PCR and sequencing for the 14 STD-causing microorganisms are summarized in Table 10.

TABLE 10
Multiplex PCR and sequencing for 14 STD-causing microorganisms

| | | Positive in | Positive in | |
|---|---|---|---|---|
| | Number of | STD multiplex | automated | Coincidence |
| Clinical sample | samples | chip assay | sequencing | (%) |
| Neisseria gonorrhoea | 50 | 50 | 50 | 100% |
| Chlamydiat rachomatis | 50 | 50 | 50 | 100% |
| Ureaplasma urealyticum | 50 | 49 | 50 | 98% |
| Mycoplasma genitalium | 50 | 47 | 50 | 94% |
| Mycoplasma hominis | 50 | 48 | 50 | 96% |
| Trichomonas vaginalis | 50 | 49 | 50 | 98% |
| Gardnerella vaginalis | 50 | 47 | 50 | 94% |
| Candida albicans | 1 | 1 | 1 | 100% |
| Treponema pallidum | 50 | 50 | 50 | 100% |
| HSV-1 | 50 | 50 | 50 | 100% |
| HSV-2 | 50 | 50 | 50 | 100% |
| HPV | 50 | 50 | 50 | 100% |
| Negative | 50 | 0 | 0 | 100% |
| Complicated infection | 40 | 39 | 40 | 97.5% |
| Total | 641 | 580 | 591 | 98.3% |

Table 11 shows the incidence of infections by Neisseria gonorrhoeae and Chlamydia trachomatis in 2001 and 2007, according to the Korea Centers for Disease Control and Prevention. It can be seen that whereas infection by Neisseria gonorrhoeae is decreasing, infection by Chlamydia trachomatis is increasing very fast (especially in women). This is also the case in the US.

TABLE 11
Trend of STD in Korea

| | Incidence in 2001 | Incidence in 2007 |
|---|---|---|
| Neisseria gonorrhea | 18,392 | 3,115 |
| Chlamydia trachomatis | 354 | 3,196 |

(2007 Communicable Disease Surveillance Yearbook, Publishing Registration No.: 11-1460193-000004-10)

### Example 10

### Probe Designing for Hybridization Assay

In order to prepare a DNA chip for genotyping the hybridization 14 STD-causing microorganisms and the PCR product of the control gene at once on a single chip, first, a combination of oligonucleotide probes having appropriate base sequences was designed. This is a fundamental step of developing the DNA chip of the present invention, that is the process of designing and preparing oligonucleotide probes which will be integrated on the DNA chip.

The GeneBank database of the National Center for Biotechnology Information (NCBI) and the database of the genes of the 14 STD-causing microorganisms obtained in Example 7 and human beta-globin gene found in Koreans were analyzed, and base sequence of each genotype determined. The obtained DNA sequence was subjected to pairwise alignment and multiple sequence alignment by means of ClustalW using the computer program MegAlign™ 5 (DNASTAR, Inc.), and then the phylogenetic tree was completed and the type-specific base sequence of each group was selected. Next, a type-specific probe was designed using the computer program Primer Premier 5 (PREMIER Biosoft International Co.). For the probes, oligonucleotides 20±2 by and 18±2 by long were used. A total of 30 genotype-specific probes were designed. The probe for human beta-globin gene having a base sequence of SEQ ID No. 66 is for use as a corner marker of the chip of the present invention. It may be detected using an oligonucleotide of SEQ ID No. 67, which was prepared by labeling the 5′ end of the reverse sequence of SEQ ID No. 66 with Cy5. The names, SEQ ID Nos. and genotypes of these probes are summarized in

TABLE 12

| | | SEQ | | | | | |
|---|---|---|---|---|---|---|---|
| Microorganism/ | | ID. | | Loca- | | | % |
| gene | Name | NO. | Base sequence | tion | Length | Tm | GC |
| UU | UUP-1 | 37 | GTGCAAATGTGATCCAACTTGG | 69 | 22 | 63.2 | 45 |
| NG | NGP-1 | 38 | GATATTTTTCCGTAACGTCTCTAAGTCT | 7 | 28 | 59.8 | 48 |
| | NGP-2 | 39 | GTCTCTAAGTCTGCTTTCGTTTGTTG | 23 | 26 | 61.7 | 41.66 |
| CT | CTP-1 | 40 | TTTTCTTCGTCAGTTAAACCTTCCC | 203 | 25 | 59.9 | 40 |
| | CTP-2 | 41 | GATAGGACATGGCTCTACAACGAAC | 124 | 22 | 59.8 | 40.9 |
| MH | MHP-1 | 42 | ATTTGCAATAGGAAATGATTGCAGA | 278 | 25 | 59.8 | 32 |
| GV | GVP-1 | 43 | AGGCTAAACCGAGTACGTGTGA | 206 | 22 | 57.6 | 50 |
| MG | MGP-1 | 44 | CCATTACTGACGCTTAGGCTTGA | 88 | 23 | 59.4 | 48 |
| TV | TVP-1 | 45 | GCAAAGGCAGTCCTTGACAAC | 6 | 21 | 60 | 52 |
| CA | CAP-1 | 46 | TGACAATGGCTTAGGTCTAACCAAA | 30 | 25 | 59.9 | 40 |
| HSV | HSVu1P-1 | 47 | AGGGCGGCGACTTTGACGA | 297 | 17 | 65.2 | 76 |
| | HSVu2P-2 | 48 | GGGAGGAAGGCGCGGAGGGG | 288 | 17 | 69 | 82 |
| TP | TPP-1 | 49 | ACGTGCAGAAAAACTATCCTCAGTG | 93 | 25 | 59.7 | 44 |
| | TPP-3 | 50 | TCTCCATGCTGCTTACCTTACGT | 114 | 23 | 59 | 47.82 |
| HD | HDP-1 | 51 | GTGAGTAATGCTTGGGAATCTGGCTT | 34 | 26 | 59.8 | 55 |
| | HDP-2 | 52 | TGTAGCTAATACCGCGTAATATCTTC | 85 | 26 | 58.1 | 38 |
| HPV | HPVP-1 | 53 | TTGTTGGGDTAATCAGTTGTTTGTTACTGT | 3 | 30 | 54.2 | 38.46 |
| | HPVP-2 | 54 | TTTGTTACTGTTGTAGATACTACTCGCAGTAC | 25 | 32 | 65.3 | 46 |
| 16s RNA | 16sP | 55 | CGTATTACCGCGGCTGCTGGCAC | 152 | 23 | 69.9 | 65.21 |
| TetM | TetM-2P | 56 | CTGCCGAAATTGTAATCAAACAGAAGG | 206 | 27 | 63.2 | 42.85 |
| | TetM-5P | 57 | TACTGATTTCTGCAAAAGATGGCGT | 50 | 25 | 57.9 | 45.45 |
| TetC | TetC-2P | 58 | GGCATGACTATCGTCGCCGCAC | 70 | 22 | 59.8 | 48 |
| | TetC-6P | 59 | GCATGACTATCGTCGCCGCACTTAT | 71 | 25 | 61.7 | 41.66 |
| TEM | TEM-1P | 60 | GCTGAATGAAGCCATACCAAACGACGAG | 290 | 28 | 59.9 | 40 |
| | TEM-2P | 61 | TGAATGAAGCCATACCAAACGACGAG | 288 | 26 | 52.8 | 40 |
| AmpC | AmpC-1P | 62 | ATACTGGCCTGAACTTACCGCTAAAC | 77 | 26 | 59.8 | 32 |
| | AmpC-2P | 63 | TGGCCTGAACTTACCGCTAAACA | 73 | 23 | 64.1 | 50 |
| SHV | SHV-6P | 64 | CCAGCCAGCGTCTGAGCGCCCGTT | 370 | 24 | 59.8 | 48 |
| | SHV-10P | 65 | GGGAAACGGAACTGAATGAGGCGC | 280 | 24 | 57.6 | 50 |
| HBB | HBB-1P | 66 | GAGGAGAAGTCTGCCG | | 16 | 57.6 | 62.5 |
| | HBB-AS | 67 | Cy5-CGGCAGACTTCTCCTC | | 16 | 57.6 | 62.5 |

(* Location means the location of the probe on the base sequence of the PCR product, excluding the forward and reverse primer sequences. D means G, A or T.)

### Example 11

### Preparation of DNA Chip

The oligonucleotide probes designed in Example 10 were mixed with appropriate reagents and then integrated on a glass slide for a microscope using an arrayer to prepare an oligonucleotide microarray or an oligo DNA chip for detection and genotyping of STD-causing microorganisms. Furthermore, a modified chip having 8 grids on one chip wherein 8 different samples may be integrated thereon for simultaneous assay was also prepared (see FIG. 1).

1. Integration of Probes for STD-Causing Microorganisms and Antibiotic Resistance Genes on DNA Chip

Grids were formed in groups such that, after hybridization on a chip, specific microorganism can be easily detected by the fluorescence signal corresponding to the genotype of the STD-causing microorganism. The order of probes and the grid arrangement are schematically shown in FIG. 1. FIG. 1 A shows a photograph of the DNA chip of the present invention. DNA probes are spotted on a slide at 8 different wells, so that different samples can be detected at the same time. FIG. 1 B schematically shows the order and location of the DNA probes for genotyping the genomic genes or plasmid genes of the 14 STD-causing microorganisms and for genotyping the genes related with antibiotic resistance. FIG. 1 C shows a fluorescence scanner image of a sample coinfected by Neisseria gonorrhoeae, Chlamydia trachomatis and HSV-1 and including genes resistant to penicillin- and tetracycline-based antibiotics, obtained with the DNA chip of the present invention.

Each oligonucleotide probe was spotted using an arrayer. At this time, the same probes were integrated in duplicate so that each genotype of the microorganism appears at least twice and at most 4 times.

One of the most important modifications of the DNA chip of the present intention was to equally divide grids into 8 wells on one chip using a well cover. With this, 8 different samples can be detected on one chip, which is very useful in reducing time, labor and cost (FIG. 1).

2. Preparation of Solution for Spotting Oligonucleotide Probes onto Chip and Division onto Master Plate

The oligonucleotide probes designed according to Example 10 and synthesized by attaching amine onto C6 position were purified by high performance liquid chromatography (HPLC), and then dissolved in sterilized triply distilled water to a final concentration of 200 pM. Thus prepared probes were mixed with microspotting solution Plus (Telechem, TC-MSP, USA) in a proportion of 4.3 times to a final concentration of 38 μM. For example, to 7.6 μL of probes at 200 pM concentration, 32.4 μL of the spotting solution was mixed to make 40 μL. Thus prepared mixture was divided into a 96-well master plate.

3. Fixation of Oligonucleotide Probes

Using an arrayer, the spotting solution containing the probes was transferred from the master plate to a specially coated glass slide and integrated thereto by double hit. A volume of about 0.005 μL on average was integrated in one spot. As for the glass slide, Nuricell aldehyde glass slide (Nuricell, Korea), 7.5×2.5 cm in size and coated with super aldehyde, or a product comparable thereto is preferred. For the arrayer, Q arrayer2 (Genetixs, UK), MGII (Biorobotics Inc, MA01801, USA) or an equipment comparable thereto is preferred.

The DNA chip prepared by integrating the probes onto the glass slide was reacted at room temperature for 15 minutes inside a glass jar maintained at a humidity of 80%.

4. Post-Treatment Process

After completion of the reaction, the fixated slide was baked in a drying oven for 1.5 hours at 120° C. Then, the slide was washed in 0.2% sodium dodecylsulfate (SDS) solution twice for 2 minutes, and then transferred to triply distilled water and washed twice for 2 minutes. Thereafter, the slide was dipped in triply distilled water heated to 95° C. for 3 minutes, whereby the oligonucleotide probes attached on the slide were denatured, and washed in triply distilled water for 1 minute. After washing, the slide was reduced for 15 minutes in blocking solution (1 g of NaBH₄, 300 mL of PBS and 100 mL of ethanol), washed in 0.2% SDS solution twice for 2 minutes, and then transferred to triply distilled water and washed twice for 2 minutes. Water on the slide was removed by centrifuging at 800 rpm for 1 minute and 30 seconds, and then the slide was put in a slide box and stored in a desiccator at room temperature.

The conditions and qualities of thus prepared chip were observed and controlled as described in Example 12.

### Example 12

### Hybridization Assay on DNA Chip and Result Analysis

The artificial samples made by mixing the plasmid clones of each STD-causing microorganism and the plasmid clones of human beta-globin gene in various combinations and concentrations in Example 8 were subjected to multiplex PCR. The products were integrated on the STD DNA chip prepared in Example 11 and subjected to hybridization reaction for multiple times. Then, the chip was analyzed using a fluorescence scanner to establish the optimized conditions. The method thereof is as follows and the results are shown in FIGS. 42 to 44.

1. Multiplex PCR

The multiplex PCR was performed in accordance with Examples 8 and 9.

2. Hybridization Reaction

On the slide chip to which the oligonucleotide probes were spotted, each 10 μL of the PCR product of each gene was mixed, with the sample DNA as main substance, to a final volume of 50 μL. After denaturation at 95° C. for 5 minutes, the mixture was immediately placed on ice and left to stand for 3 minutes. Thereafter 50 μL of hybridization reaction solution was added thereto to adjust the final volume to 100 μL and then the mixture was reacted for 30 minutes at 45° C. with the probes fixated on the slide. The hybridization reaction solution was prepared by mixing 2 mL of 20×SSC, 1.7 mL of 90% glycerol and 6.3 mL of 50 mM phosphate buffer solution to make the final volume 10 mL.

3. Washing

After completion of the hybridization reaction, the well cover was removed from the DNA chip, and the chip was dipped in 3×SSPE solution [NaCl (26.295 g), NaH₂PO₄.1H₂O (4.14 g), Na₂EDTA (1.11 g) dissolved in 1 L of distilled water, with pH adjusted to 7.4 using 10 N NaOH] and washed for 2 minutes at room temperature. The chip was further washed with 1×SSPE solution [NaCl (8.765 g), NaH₂PO₄.1H₂O (1.38 g), Na₂EDTA (0.37 g) dissolved in 1 L of distilled water, with pH adjusted to 7.4 using 10 N NaOH], washed for 2 minutes at room temperature, and dried by centrifuging at 800 rpm, at room temperature, for 1 minute and 30 seconds.

4. Scanning Analysis

After removal of nonspecific signals through washing, the dried slide was subjected to analysis of fluorescence signals and images using a fluorescence scanner. As for the scanner, GenePix 4000B Scanner (Axon, USA), ScanArray Lite (Packard Bioscience, USA) or an equipment comparable thereto are preferred.

### Example 13

### Verification of DNA Chip According to the Present Invention

DNAs of various human samples, which had been identified to be infected by the STD-causing microorganisms in Example 7 through PCR and sequencing and used for analyzing accuracy of multiplex PCR in Example 9, were subjected to multiplex PCR again, and the PCR products were integrated on the STD DNA chip prepared in Examples 11 and 12 and subjected to hybridization reaction ad described in Example 12. Then, the result was analyzed using a fluorescence scanner. The DNA samples included as test subjects are listed in Table 10.

The sensitivity, specificity and reproducibility of the DNA chip assay were evaluated by repeating the same tests twice with a time interval by different operators. Thereby, it was evaluated whether the DNA chip of the present invention is capable of accurately detecting the 14 STD-causing microorganisms, clinically, in particular, whether it is capable of accurately detecting the complicated infection as well.

The comparative results of the STD DNA chip assay and single PCR and sequencing assay are summarized in Table 10.

With respect to the sequencing after single PCR, the sensitivity of the DNA chip assay was 98 to 100%, 99% on average, and the specificity was 100%. The reproducibility was 99%. These results showed that the specificity of the DNA chip was more excellent than the multiplex PCR, and the diagnosis sensitivity of the complicated infection was also superior.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

1. A DNA chip for detecting and genotyping sexually transmitted disease (STD)-causing microorganisms and for analyzing their antibiotic resistance, comprising oligonucleotide probes having base sequences of SEQ ID Nos. 37 to 66.

2. The DNA chip according to claim 1, wherein the oligonucleotide probe having a base sequence of SEQ ID No. 66 binds complementarily to a human beta-globin gene.

3. The DNA chip according to claim 1, wherein the oligonucleotide probe having a base sequence of SEQ ID No. 66 binds complementarily to an oligonucleotide having a base sequence of SEQ ID No. 67 with the 5′ end labeled with Cy5.

4. The DNA chip according to claim 1, wherein an area of the DNA chip on which the probe is spotted is partitioned into 8 wells.

5. A kit for detecting and genotyping STD-causing microorganisms and analyzing their antibiotic resistance, comprising the DNA chip according to claim 1, a primer set for amplifying DNAs of STD-causing microorganisms, and a labeling means for detecting the amplified DNAs binding complementarily to the DNA chip.

6. The kit according to claim 5, wherein the primer set is a primer set for amplifying nucleic acids of Gardnerella vaginalis having base sequences of SEQ ID No. 1 and SEQ ID No. 2, a primer set for amplifying nucleic acids of Ureaplasma urealyticum having base sequences of SEQ ID No. 3 and SEQ ID No. 4, a primer set for amplifying nucleic acids of Mycoplasma hominis having base sequences of SEQ ID No. 5 and SEQ ID No. 6, a primer set for amplifying nucleic acids of Chlamydia trachomatis having base sequences of SEQ ID No. 7 and SEQ ID No. 8, a primer set for amplifying nucleic acids of Neisseria gonorrhoeae having base sequences of SEQ ID No. 9 and SEQ ID No. 10, a primer set for amplifying nucleic acids of Trichomonas vaginalis having base sequences of SEQ ID No. 11 and SEQ ID No. 12, a primer set for amplifying nucleic acids of Mycoplasma genitalium having base sequences of SEQ ID No. 13 and SEQ ID No. 14, a primer set for amplifying nucleic acids of Candida albicans having base sequences of SEQ ID No. 15 and SEQ ID No. 16, a primer set for amplifying nucleic acids of coliform bacteria having base sequences of SEQ ID No. 17 and SEQ ID No. 18, a primer set for amplifying nucleic acids of Haemophilus ducreyi having base sequences of SEQ ID No. 19 and SEQ ID No. 20, a primer set for amplifying nucleic acids of herpes simplex virus (HSV) having base sequences of SEQ ID No. 21 and SEQ ID No. 22, a primer set for amplifying nucleic acids of Treponema pallidum having base sequences of SEQ ID No. 23 and SEQ ID No. 24, a primer set for amplifying nucleic acids of human papillomavirus (HPV) having base sequences of SEQ ID No. 25 and SEQ ID No. 26, a primer set for amplifying SHV gene (beta-lactamase SHV-12 gene) having base sequences of SEQ ID No. 27 and SEQ ID No. 28, a primer set for amplifying TEM gene (CMT-type beta lactamase gene) having base sequences of SEQ ID No. 29 and SEQ ID No. 30, a primer set for amplifying TetM gene (tetracycline resistant gene M) having base sequences of SEQ ID No. 31 and SEQ ID No. 32, a primer set for amplifying AmpC gene (cephalosporinase gene) having base sequences of SEQ ID No. 33 and SEQ ID No. 34, or a primer set for amplifying TetC gene (tetracycline resistant gene C) having base sequences of SEQ ID No. 35 and SEQ ID No. 36.

7. The kit according to claim 5, wherein the labeling means is one or more selected from a group consisting of Cy5, Cy3, biotinylated material, EDANS (5-(2′-aminoethyl)amino-1-naphthalenesulfonic acid), tetramethylrhodamine (TMR), tetramethylrhodamine isothiocyanate (TMRITC), x-rhodamine and Texas Red.

8. The kit according to claim 7, wherein the labeling means is Cy5 and labeled dCTP and unlabeled dCTP are reacted at a molar ratio of 1:12.5.

9. A method for detecting and genotyping STD-causing microorganisms and analyzing their antibiotic resistance, comprising:
(a) amplifying DNAs of STD-causing microorganisms by single or multiplex PCR using a primer for amplifying nucleic acids of the STD-causing microorganisms;
(b) hybridizing the amplified DNAs on the DNA chip according to claim 1; and
(c) detecting the hybridized product.

10. The method according to claim 9, wherein the amplification by single or multiplex PCR is carried out using one or more primer set(s) selected from a group consisting of a primer set for amplifying nucleic acids of Gardnerella vaginalis having base sequences of SEQ ID No. 1 and SEQ ID No. 2, a primer set for amplifying nucleic acids of Ureaplasma urealyticum having base sequences of SEQ ID No. 3 and SEQ ID No. 4, a primer set for amplifying nucleic acids of Mycoplasma hominis having base sequences of SEQ ID No. 5 and SEQ ID No. 6, a primer set for amplifying nucleic acids of Chlamydia trachomatis having base sequences of SEQ ID No. 7 and SEQ ID No. 8, a primer set for amplifying nucleic acids of Neisseria gonorrhoeae having base sequences of SEQ ID No. 9 and SEQ ID No. 10, a primer set for amplifying nucleic acids of Trichomonas vaginalis having base sequences of SEQ ID No. 11 and SEQ ID No. 12, a primer set for amplifying nucleic acids of Mycoplasma genitalium having base sequences of SEQ ID No. 13 and SEQ ID No. 14, a primer set for amplifying nucleic acids of Candida albicans having base sequences of SEQ ID No. 15 and SEQ ID No. 16, a primer set for amplifying nucleic acids of coliform bacteria having base sequences of SEQ ID No. 17 and SEQ ID No. 18, a primer set for amplifying nucleic acids of Haemophilus ducreyi having base sequences of SEQ ID No. 19 and SEQ ID No. 20, a primer set for amplifying nucleic acids of herpes simplex virus (HSV) having base sequences of SEQ ID No. 21 and SEQ ID No. 22, a primer set for amplifying nucleic acids of Treponema pallidum having base sequences of SEQ ID No. 23 and SEQ ID No. 24, a primer set for amplifying nucleic acids of human papillomavirus (HPV) having base sequences of SEQ ID No. 25 and SEQ ID No. 26, a primer set for amplifying SHV gene (beta-lactamase SHV-12 gene) having base sequences of SEQ ID No. 27 and SEQ ID No. 28, a primer set for amplifying TEM gene (CMT-type beta lactamase gene) having base sequences of SEQ ID No. 29 and SEQ ID No. 30, a primer set for amplifying TetM gene (tetracycline resistant gene M) having base sequences of SEQ ID No. 31 and SEQ ID No. 32, a primer set for amplifying AmpC gene (cephalosporinase gene) having base sequences of SEQ ID No. 33 and SEQ ID No. 34, and a primer set for amplifying TetC gene (tetracycline resistant gene C) having base sequences of SEQ ID No. 35 and SEQ ID No. 36.

11. The method according to claim 10, wherein the amplification by single or multiplex PCR comprises:
(a) mixing the primer set with template DNA, Taq DNA polymerase, dNTP, distilled water and PCR buffer;
(b) predenaturing the resulting mixture at 95° C. for 10 minutes;
(c) subjecting the resulting product to 40 cycles of denaturation at 94° C. for 30 seconds, primer annealing at 58° C. for 30 seconds and extension at 72° C. for 30 seconds; and
(d) subjecting the resulting product to final extension at 72° C. for 5 minutes.

12. The method according to claim 9, wherein the amplification by multiplex PCR is carried out using a primer set having base sequences of SEQ ID No. 1 and SEQ ID No. 2, a primer set having base sequences of SEQ ID No. 3 and SEQ ID No. 4, a primer set having base sequences of SEQ ID No. 5 and SEQ ID No. 6, a primer set having base sequences of SEQ ID No. 7 and SEQ ID No. 8, a primer set having base sequences of SEQ ID No. 9 and SEQ ID No. 10, a primer set having base sequences of SEQ ID No. 11 and SEQ ID No. 12, a primer set having base sequences of SEQ ID No. 13 and SEQ ID No. 14 and a primer set having base sequences of SEQ ID No. 15 and SEQ ID No. 16 at a molar ratio of 1:1:1:1:1:1:1:1.

13. The method according to claim 9, wherein the amplification by multiplex PCR is carried out using a primer set having base sequences of SEQ ID No. 17 and SEQ ID No. 18, a primer set having base sequences of SEQ ID No. 19 and SEQ ID No. 20, a primer set having base sequences of SEQ ID No. 21 and SEQ ID No. 22, a primer set having base sequences of SEQ ID No. 23 and SEQ ID No. 24 and a primer set having base sequences of SEQ ID No. 25 and SEQ ID No. 26 at a molar ratio of 1:1:1:1:1.

14. The method according to claim 9, wherein the amplification by multiplex PCR is carried out using a primer set having base sequences of SEQ ID No. 27 and SEQ ID No. 28, a primer set having base sequences of SEQ ID No. 29 and SEQ ID No. 30, a primer set having base sequences of SEQ ID No. 31 and SEQ ID No. 32, a primer set having base sequences of SEQ ID No. 33 and SEQ ID No. 34 and a primer set having base sequences of SEQ ID No. 35 and SEQ ID No. 36 at a molar ratio of 1:1:1:1:1.

15. The method according to claim 12, wherein a PCR product by the primer set having base sequences of SEQ ID No. 1 and SEQ ID No. 2 has a size of 419 bp, a PCR product by the primer set having base sequences of SEQ ID No. 3 and SEQ ID No. 4 has a size of 373 bp, a PCR product by the primer set having base sequences of SEQ ID No. 5 and SEQ ID No. 6 has a size of 333 bp, a PCR product by the primer set having base sequences of SEQ ID No. 7 and SEQ ID No. 8 has a size of 321 bp, a PCR product by the primer set having base sequences of SEQ ID No. 9 and SEQ ID No. 10 has a size of 284 bp, a PCR product by the primer set having base sequences of SEQ ID No. 11 and SEQ ID No. 12 has a size of 262 bp, a PCR product by the primer set having base sequences of SEQ ID No. 13 and SEQ ID No. 14 has a size of 207 bp, and a PCR product by the primer set having base sequences of SEQ ID No. 15 and SEQ ID No. 16 has a size of 148 bp.

16. The method according to claim 13, wherein a PCR product by the primer set having base sequences of SEQ ID No. 17 and SEQ ID No. 18 has a size of 467 bp, a PCR product by the primer set having base sequences of SEQ ID No. 19 and SEQ ID No. 20 has a size of 439 bp, a PCR product by the primer set having base sequences of SEQ ID No. 21 and SEQ ID No. 22 has a size of 350 bp, a PCR product by the primer set having base sequences of SEQ ID No. 23 and SEQ ID No. 24 has a size of 260 bp, and a PCR product by the primer set having base sequences of SEQ ID No. 25 and SEQ ID No. 26 has a size of 191 bp.

17. The method according to claim 14, wherein a PCR product by the primer set having base sequences of SEQ ID No. 27 and SEQ ID No. 28 has a size of 679 bp, a PCR product by the primer set having base sequences of SEQ ID No. 29 and SEQ ID No. 30 has a size of 412 bp, a PCR product by the primer set having base sequences of SEQ ID No. 31 and SEQ ID No. 32 has a size of 291 bp, a PCR product by the primer set having base sequences of SEQ ID No. 33 and SEQ ID No. 34 has a size of 208 bp, and a PCR product by the primer set having base sequences of SEQ ID No. 35 and SEQ ID No. 36 has a size of 152 bp.

18. A kit for detecting and genotyping STD-causing microorganisms and analyzing their antibiotic resistance, comprising the DNA chip according to claim 2, a primer set for amplifying DNAs of STD-causing microorganisms, and a labeling means for detecting the amplified DNAs binding complementarily to the DNA chip.

19. A kit for detecting and genotyping STD-causing microorganisms and analyzing their antibiotic resistance, comprising the DNA chip according to claim 3, a primer set for amplifying DNAs of STD-causing microorganisms, and a labeling means for detecting the amplified DNAs binding complementarily to the DNA chip.

20. A kit for detecting and genotyping STD-causing microorganisms and analyzing their antibiotic resistance, comprising the DNA chip according to claim 4, a primer set for amplifying DNAs of STD-causing microorganisms, and a labeling means for detecting the amplified DNAs binding complementarily to the DNA chip.


SEQUENCE LISTING (67 sequences)

SEQ ID NO: 1 - DNA, 18 bp, Gardnerella vaginalis
gttggatgccttggtaga

SEQ ID NO: 2 - DNA, 23 bp, Gardnerella vaginalis
gctacttgggaataaacataaaa

SEQ ID NO: 3 - DNA, 22 bp, Ureaplasma urealyticum
agcaattaacttcgctgaaggc

SEQ ID NO: 4 - DNA, 23 bp, Ureaplasma urealyticum
taaacataatgttccccttcgtc

SEQ ID NO: 5 - DNA, 21 bp, Mycoplasma hominis
aatggctaatgccggatacgc

SEQ ID NO: 6 - DNA, 21 bp, Mycoplasma hominis
gtaccgtcagtctgcaatcat

SEQ ID NO: 7 - DNA, 28 bp, Chlamydia trachomatis
taatagtggcaactagaactcgatggac

SEQ ID NO: 8 - DNA, 26 bp, Chlamydia trachomatis
ctgctgtaatcacccagtcgataaat

SEQ ID NO: 9 - DNA, 19 bp, Neisseria gonorrhoeae
gctcgctttgcttcaatgc

SEQ ID NO: 10 - DNA, 20 bp, Neisseria gonorrhoeae
gccctatcaggcaagctaaa

SEQ ID NO: 11 - DNA, 25 bp, Trichomonas vaginalis
attgtcgaacattggtcttaccctc

SEQ ID NO: 12 - DNA, 22 bp, Trichomonas vaginalis
tctgtgccgtcttcaagtatgc

SEQ ID NO: 13 - DNA, 24 bp, Mycoplasma genitalium
gcattggaaactatcagtctagag

SEQ ID NO: 14 - DNA, 23 bp, Mycoplasma genitalium
gctccgacagctagtatctatcg

SEQ ID NO: 15 - DNA, 20 bp, Candida albicans
tacgacttgggtttgcttga

SEQ ID NO: 16 - DNA, 21 bp, Candida albicans
gcgggtagtcctacctgattt

SEQ ID NO: 17 - DNA, 19 bp, Unknown
  Coliform bacteria
tcctacgggaggcagcagt

SEQ ID NO: 18 - DNA, 26 bp, Unknown
  Coliform bacteria
ggactaccagggtatctaatcctgtt

SEQ ID NO: 19 - DNA, 22 bp, Haemophilus ducreyi
caagtcgaacggtagcacgaag

SEQ ID NO: 20 - DNA, 27 bp, Haemophilus ducreyi
ttctgtgactaacgtcaatcaattttg

SEQ ID NO: 21 - DNA, 17 bp, herpes simplex virus
aacgccgccatgttcgc

SEQ ID NO: 22 - DNA, 17 bp, herpes simplex virus
cgctccatggccgacac

SEQ ID NO: 23 - DNA, 22 bp, Treponema pallidum
gaagtttgtcccagttgcggtt

SEQ ID NO: 24 - DNA, 21 bp, Treponema pallidum
cagagccatcagcccttttca

SEQ ID NO: 25 - DNA, 20 bp, Human papillomavirus
gcmcagggwcataayaatgg

SEQ ID NO: 26 - DNA, 30 bp, Human papillomavirus
ttttttaataaactgtaaatcatattcctc

SEQ ID NO: 27 - DNA, 20 bp, Unknown
  SHV(beta-lactamase SHV12)
ctttcccatgatgagcacct

SEQ ID NO: 28 - DNA, 18 bp, Unknown
  SHV(beta-lactamase SHV12)
tagcgttgccagtgctcg

SEQ ID NO: 29 - DNA, 20 bp, Unknown
  TEM(CMT-type beta lactamase gene)
gaggaccgaaggagctaacc

SEQ ID NO: 30 - DNA, 19 bp, Unknown
  TEM(CMT-type beta lactamase gene)
atctcagcgatctgtctat

SEQ ID NO: 31 - DNA, 20 bp, Unknown
  TetM(Transposon Tn916-tetracycline resistant gene)
acacgccaggacatatggat

SEQ ID NO: 32 - DNA, 20 bp, Unknown
  TetM(Transposon Tn916-tetracycline resistant gene)
cggtaaagttcgtcacacac

SEQ ID NO: 33 - DNA, 20 bp, Unknown
  AmpC(cephalosporinase gene)
ggttcggtcagcaaaacatt

SEQ ID NO: 34 - DNA, 20 bp, Unknown
  AmpC(cephalosporinase gene)
gcaagtcgcttgaggatttc

SEQ ID NO: 35 - DNA, 20 bp, Unknown
  TetC(tetracycline resistant gene)
gcttcctaatgcaggagtcg

SEQ ID NO: 36 - DNA, 20 bp, Unknown
  TetC(tetracycline resistant gene)
ggcacctgtcctacgagttg

SEQ ID NO: 37 - DNA, 22 bp, Artificial Sequence
  Probe for Ureaplasma urealyticum
gtgcaaatgtgatccaacttgg

SEQ ID NO: 38 - DNA, 28 bp, Artificial Sequence
  Probe for Neisseria gonorrhoeae
gatatttttccgtaacgtctctaagtct

SEQ ID NO: 39 - DNA, 26 bp, Artificial Sequence
  Probe for Neisseria gonorrhoeae
gtctctaagtctgctttcgtttgttg

SEQ ID NO: 40 - DNA, 25 bp, Artificial Sequence
  Probe for Chlamydia trachomatis
ttttcttcgtcagttaaaccttccc

SEQ ID NO: 41 - DNA, 25 bp, Artificial Sequence
  Probe for Chlamydia trachomatis
gataggacatggctctacaacgaac

SEQ ID NO: 42 - DNA, 25 bp, Artificial Sequence
  Probe for Mycoplasma hominis
atttgcaataggaaatgattgcaga

SEQ ID NO: 43 - DNA, 22 bp, Artificial Sequence
  Probe for Gardnerella vaginalis
aggctaaaccgagtacgtgtga

SEQ ID NO: 44 - DNA, 23 bp, Artificial Sequence
  Probe for Mycoplasma genitalium
ccattactgacgcttaggcttga

SEQ ID NO: 45 - DNA, 21 bp, Artificial Sequence
  Probe for Trichomonas vaginalis
gcaaaggcagtccttgacaac

SEQ ID NO: 46 - DNA, 25 bp, Artificial Sequence
  Probe for Candida albicans
tgacaatggcttaggtctaaccaaa

SEQ ID NO: 47 - DNA, 19 bp, Artificial Sequence
  Probe for herpes simplex virus
agggcggcgactttgacga

SEQ ID NO: 48 - DNA, 20 bp, Artificial Sequence
  Probe for herpes simplex virus
gggaggaaggcgcggagggg

SEQ ID NO: 49 - DNA, 25 bp, Artificial Sequence
  Probe for Treponema pallidum
acgtgcagaaaaactatcctcagtg

SEQ ID NO: 50 - DNA, 23 bp, Artificial Sequence
  Probe for Treponema pallidum
tctccatgctgcttaccttacgt

SEQ ID NO: 51 - DNA, 26 bp, Artificial Sequence
  Probe for Haemophilus ducreyi
gtgagtaatgcttgggaatctggctt

SEQ ID NO: 52 - DNA, 26 bp, Artificial Sequence
  Probe for Haemophilus ducreyi
tgtagctaataccgcgtaatatcttc

SEQ ID NO: 53 - DNA, 30 bp, Artificial Sequence
  Probe for human papillomavirus
ttgttgggdtaatcagttgtttgttactgt

SEQ ID NO: 54 - DNA, 32 bp, Artificial Sequence
  Probe for human papillomavirus
tttgttactgttgtagatactactcgcagtac

SEQ ID NO: 55 - DNA, 23 bp, Artificial Sequence
  Probe for Coliform bacteria
cgtattaccgcggctgctggcac

SEQ ID NO: 56 - DNA, 27 bp, Artificial Sequence
  Probe for TetM
ctgccgaaattgtaatcaaacagaagg

SEQ ID NO: 57 - DNA, 25 bp, Artificial Sequence
  Probe for TetM
tactgatttctgcaaaagatggcgt

SEQ ID NO: 58 - DNA, 22 bp, Artificial Sequence
  Probe for TetC
ggcatgactatcgtcgccgcac

SEQ ID NO: 59 - DNA, 25 bp, Artificial Sequence
  Probe for TetC
gcatgactatcgtcgccgcacttat

SEQ ID NO: 60 - DNA, 28 bp, Artificial Sequence
  Probe for TEM
gctgaatgaagccataccaaacgacgag

SEQ ID NO: 61 - DNA, 26 bp, Artificial Sequence
  Probe for TEM
tgaatgaagccataccaaacgacgag

SEQ ID NO: 62 - DNA, 26 bp, Artificial Sequence
  Probe for AmpC
atactggcctgaacttaccgctaaac

SEQ ID NO: 63 - DNA, 23 bp, Artificial Sequence
  Probe for AmpC
tggcctgaacttaccgctaaaca

SEQ ID NO: 64 - DNA, 24 bp, Artificial Sequence
  Probe for SHV
ccagccagcgtctgagcgcccgtt

SEQ ID NO: 65 - DNA, 24 bp, Artificial Sequence
  Probe for SHV
gggaaacggaactgaatgaggcgc

SEQ ID NO: 66 - DNA, 16 bp, Artificial Sequence
  Probe for Human beta-globulin
gaggagaagtctgccg

SEQ ID NO: 67 - DNA, 16 bp, Artificial Sequence
  Probe for Human beta-globulin
cggcagacttctcctc